(19) United States
(12) Patent Application Publication
(10) Pub. No.: US 2024/0054415 A1
(43) Pub. Date: Feb. 15, 2024

(54) SYSTEM AND METHOD FOR ENABLING PASSENGER TRANSPORTATION ON AUTONOMOUS COMMERCIAL VEHICLES

(71) Applicant: Cole Stevens, Blanchard, OK (US)

(72) Inventor: Cole Stevens, Blanchard, OK (US)

(21) Appl. No.: 18/448,771

(22) Filed: Aug. 11, 2023

Related U.S. Application Data
(60) Provisional application No. 63/371,329, filed on Aug. 12, 2022.

(51) Int. Cl. G06Q 10/0631

(52) U.S. Cl. CPC G06Q 10/06311

(57) ABSTRACT

Systems and methods for enabling passenger transportation on autonomous commercial vehicles are disclosed, including a system comprising processor(s), and a memory storing instructions that cause the processor(s) to: receive a trip itinerary having a pick-up region, a time, and autonomous vehicle data; receive a rideshare request identifying passenger data and having a pick-up location, a drop-off location, and a pick-up time, the passenger data being associated with a passenger device; match the rideshare request with the trip itinerary as a list of matched itineraries; generate a passenger manifest based on the autonomous vehicle data and the passenger data; book a ridesharing trip including the passenger data and the autonomous vehicle data; provide the rideshare request to the autonomous vehicle device; transmit a rideshare request confirmation to a passenger device; and store the passenger manifest in the memory.

### CROSS-REFERENCE TO RELATED APPLICATIONS

The present invention is a non-provisional patent application claiming priority to the provisional application identified by U.S. Application No. 63/371,329, filed Aug. 12, 2022, the entire content of which is hereby incorporated herein by reference.

### BACKGROUND OF THE INVENTION

Ridesharing is a method of travel where those seeking ground transportation rely on private drivers to provide transportation through the use of rideshare services.

Such rideshare services allows those seeking ground transportation to request transportation services from a particular pick-up point location to a specified drop-off point location, and allows private drivers to accept such requests based on their schedule and willingness to travel the requested route. However, private drivers are often unwilling to accept requests which require the driver to transport passengers very long distances. Traditionally, a person seeking ground transportation for long distances rely on public transportation and commercial passenger carrier services, such as commercial busses. However, those relying on public transportation and commercial passenger carrier services cannot schedule such transportation services at their own convenience, but rather must conform to posted schedules.

Commercial trucking services dispatch drivers to travel great distances on a regular basis to deliver goods across the country. These truck drivers often travel alone and make frequent stops at public rest areas. The operation of commercial trucks is heavily regulated by the government. Commercial trucking companies generally utilize a fleet of Class 8 heavy trucks, such as semi-trailer trucks, to haul freight. But before a commercial trucking company can haul freight, it must first obtain a motor carrier authority and a motor carrier number which will then be associated with its Class 8 trucks. Moreover, the drivers that operate Class 8 trucks must receive special licensing to operate such trucks. Federal regulation further prohibits the transportation of unauthorized persons on any commercial motor vehicle, unless specifically authorized in writing to do so by the trucking authority operating the commercial motor vehicle.

Additionally, current transportation models necessitate a traveler desiring to get from a start location to a destination driving a vehicle, thereby causing pollution and wear-and-tear on the vehicle, while there may be another vehicle with underutilized occupancy at or passing through the start location and to or through the destination. More specifically, autonomous vehicles may leave from or pass through the start location and drive to or through the destination without a traveler, in which case, this transportation model results in two vehicles traveling along the same path with only one traveler, thereby doubling the amount of carbon emissions per traveler.

Traditionally, rideshare services and commercial trucking services have relied on human-operated vehicles. Recently, however, the consuming public has become more comfortable utilizing vehicles with autonomous driving capability and sharing the road with such vehicles. Autonomous vehicles are capable of operating in private and/or public spaces, including highways and major road systems. Further, autonomous vehicles are able to control, for example, speed, propulsion, braking, steering, and navigation based on its particular location and surroundings. As such, autonomous vehicles may be able to reduce or eliminate the need for human intervention in various aspects of vehicle operation. Accordingly, autonomous vehicles may also reduce the instances and severity of vehicular accidents caused, at least in part, by human error. Furthermore, with the emergence of autonomous vehicles, the responsibility of engaging rideshare services from autonomous vehicles falls solely on passengers, as there are no human operators to seek out scheduled passengers at pick-up locations or during intermittent stops on the way to the drop-off location. Additionally, technological issues exist in tracking autonomous vehicles and passengers, including before and during a trip, so as to intersect with autonomous vehicle pre-determined routes, ascertain passenger location, ascertain passenger presence within the autonomous vehicles, and maintaining scheduling of the autonomous vehicle.

### SUMMARY OF THE INVENTION

The addition of one or more passengers to an autonomous vehicle (e.g., a commercial truck) hauling freight has a minimal impact on the fuel efficiency of a commercial truck. As such, passengers with a desire to travel to or along the same route as commercial truck's scheduled route, passengers can be transported great distances with an insignificant amount of additional fuel and without the production of excess carbon emissions. Passenger transport by commercial truck along previously scheduled trucking routes offset net carbon emission that would have otherwise been released had the passengers opted for a different mode of transportation.

The technological problems associated with connecting, scheduling, tracking, and monitoring those seeking ground transportation and autonomous vehicles to provide transportation services, in a manner that does not contravene federal regulations, is solved by the systems and methods herein disclosed. In one implementation, an exemplary system may comprise one or more processors and one or more memories. The one or more memories comprises one or more non-transitory computer readable medium storing processor-executable instructions that when executed by the one or more processors causes the one or more processors to perform one or more of the following: receive one or more trip itineraries from a plurality of autonomous vehicle devices, each trip itinerary of the one or more trip itineraries having an autonomous vehicle identifier, at least one pick-up region along a route to a final destination, and an autonomous vehicle time associated with the at least one pick-up region, each autonomous vehicle identifier being associated with autonomous vehicle data associated with a particular autonomous vehicle, the autonomous vehicle data including an authority owner name, a motor carrier name, and a motor carrier number; receive a rideshare request from at least one passenger device, the rideshare request identifying a passenger data, and having a pickup location, a drop-off location, and a pick-up time, the at least one passenger device being associated with the passenger data identifying at least a passenger name; match the rideshare request with at least one trip itinerary of the one or more trip itinerary as a list of matched itineraries; generate a passenger manifest including the passenger name identified by the rideshare request, the autonomous vehicle data identified by a particular trip itinerary of the list of matched itineraries, and a signature of an authority owner, the passenger manifest further including at least the pick-up location, the drop-off location, a date of travel based on the autonomous vehicle time, a motor carrier name, and a motor carrier number; book a ridesharing trip including the passenger with the particular autonomous vehicle associated with the particular trip itinerary; provide the autonomous vehicle device associated with the particular trip itinerary with the rideshare request; transmit a rideshare request confirmation to the passenger device to cause the passenger device to display the rideshare request confirmation; and store the passenger manifest in the memory.

In one implementation, an exemplary method may comprise one or more of the following steps: receiving, by a host system having a host processor and a host memory, one or more trip itineraries from a plurality of autonomous vehicle devices, each trip itinerary of the one or more trip itineraries having an autonomous vehicle identifier, at least one pick-up region along a route to a final destination, and an autonomous vehicle time associated with each pick-up region, each autonomous vehicle identifier being associated with autonomous vehicle data associated with a particular autonomous vehicle, the autonomous vehicle data including an authority owner name, a motor carrier name, and a motor carrier number; receiving a rideshare request from at least one passenger device, the rideshare request identifying a passenger data, and having a pickup location, a drop-off location, and a pick-up time, the at least one passenger device being associated with the passenger data identifying at least a passenger name; matching the rideshare request with at least one trip itinerary of the one or more trip itinerary as a list of matched itineraries; generating a passenger manifest identifying the passenger name identified by the rideshare request, the autonomous vehicle data identified by a particular trip itinerary of the list of matched itineraries, and a signature of an authority owner, the passenger manifest further including at least the pick-up location, the drop-off location, a date of travel based on the autonomous vehicle time, a motor carrier name, and motor carrier number; booking a ridesharing trip including the passenger with the particular autonomous vehicle associated with the particular trip itinerary; providing the autonomous vehicle device associated with the particular trip itinerary with the rideshare request; transmitting a rideshare request confirmation to the passenger device associated with the rideshare request to cause the passenger device to display the rideshare request confirmation; and storing the passenger manifest in the host memory.

### BRIEF DESCRIPTION OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 is a diagrammatic view of hardware forming an exemplary embodiment of a system for connecting a passenger and an available autonomous vehicle, constructed in accordance with the present disclosure.

FIG. 2A is a diagrammatic view of an exemplary passenger device of FIG. 1, constructed in accordance with the present disclosure.

FIG. 2B is a diagrammatic view of an exemplary autonomous vehicle device of FIG. 1, constructed in accordance with the present disclosure.

FIG. 3 is a diagrammatic view of an exemplary embodiment of a host system for use in the system for connecting a passenger and an available autonomous vehicle illustrated in FIG. 1.

FIG. 4 is a flow diagram illustrating operation of an exemplary method of connecting a passenger and an available autonomous vehicle in accordance with the present disclosure.

FIG. 5 is an illustration of an exemplary embodiment of a passenger home screen constructed in accordance with the present disclosure.

FIG. 6 is an illustration of an exemplary embodiment of a location selection screen constructed in accordance with the present disclosure.

FIG. 7 is an illustration of an exemplary embodiment of a drop-off point selection screen constructed in accordance with the present disclosure.

FIG. 8 is an illustration of an exemplary embodiment of an autonomous vehicle selection screen constructed in accordance with the present disclosure.

FIG. 9 is an illustration of an exemplary embodiment of an autonomous vehicle profile screen constructed in accordance with the present disclosure.

FIG. 10 is an illustration of an exemplary embodiment of a passenger scheduling screen constructed in accordance with the present disclosure.

FIG. 11 is an illustration of an exemplary embodiment of the passenger trip booked screen of FIG. 10 further comprising a trip booked confirmation icon constructed in accordance with the present disclosure.

FIG. 12 is an illustration of an exemplary embodiment of a progress tracking screen constructed in accordance with the present disclosure.

FIG. 13 is an illustration of an exemplary passenger authorization manifest in accordance with some embodiments of the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The systems and methods as described in the present disclosure are capable of other embodiments or of being practiced or carried out in various ways. Also, it is to be understood that the phraseology and terminology employed herein is for purposes of description, and should not be regarded as limiting.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure, or characteristic described in connection with the embodiment is included in at least one embodiment. The appearance of the phrase “in some embodiments” or “one example” in various places in the specification is not necessarily all referring to the same embodiment, for example.

Circuitry, as used herein, may be analog and/or digital components, or one or more suitably programmed processors (e.g., microprocessors) and associated hardware and software, or hardwired logic. Also, “components” may perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that the algorithms described herein may be stored on one or more non-transitory memory. Exemplary non-transitory memory may include random access memory, read only memory, flash memory, and/or the like. Such non-transitory memory may be electrically based, optically based, and/or the like.

The term “field” means a location for computer data input and/or output of text, symbol(s) and/or value(s) having at least one corresponding associated place in computer memory.

The term “location data” means information which uniquely identifies geographic position. This may include latitude and longitude coordinates, a street address and/or otherwise.

The term “latitude and longitude coordinates” means numeric coordinates for a location on the planet corresponding to latitude (East, West) and longitude (North, South).

The term “region” means a geographic area on earth that is identified by an identifier, such as a township, a town, a city, a county, a zip code, a village, a district, an administrative division, and/or the like or a combination thereof.

The term “user-acceptance” means an affirmative step or series of steps or computer input, undertaken by user to make a selection.

The term “visual marker” is a shape, pointer, label, icon, avatar, or other indicator which is movable or displayable on a computer screen and which may be visually differentiated from other objects on the computer screen.

The term “selectable indicator” is a graphical control element associated with one or more predetermined instruction that may be selected and thus provides the user a way to execute the one or more predetermined instruction. Exemplary selection elements include, but are not limited to a button, a checkbox, a banner, or the like.

The term “autonomous vehicle” means a vehicle capable of performing all driving functions, including accelerating, braking, steering, and navigating, with little to no human supervision, input, or external control.

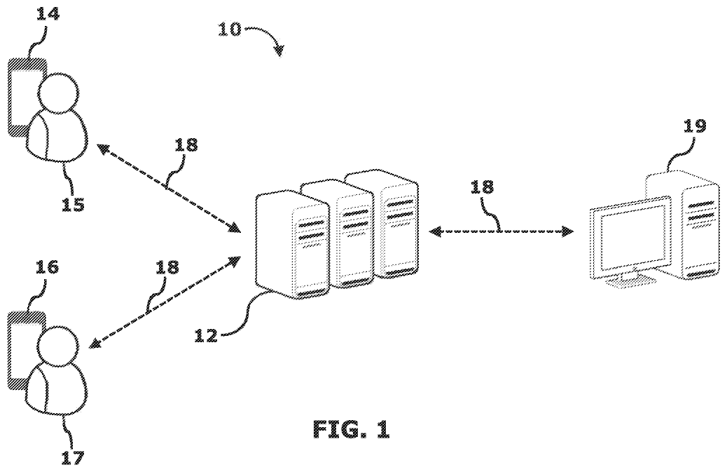

Referring now to the Figures, and in particular to FIG. 1, shown therein is a diagrammatic view of hardware forming an exemplary embodiment of a system 10 for connecting a passenger and an available autonomous vehicle in real-time constructed in accordance with the present disclosure.

The system 10 is provided with at least one host system 12 (hereinafter “host system 12”), a plurality of passenger devices 14 (hereinafter “passenger device 14”) operated by a passenger 15, a plurality of autonomous vehicle devices 16 (hereinafter “autonomous vehicle device 16”), and a network 18. In some embodiments, the system 10 may include at least one external system 19 (hereinafter “external system 19”) for use by a truck operating authority to add, delete, or modify autonomous vehicle information and privileges, manage autonomous vehicle itineraries, and manage passenger authorization manifests. The system 10 may be a system or systems that are able to embody and/or execute the logic of the processes described herein. Logic embodied in the form of software instructions and/or firmware may be executed on any appropriate hardware. For example, logic embodied in the form of software instructions and/or firmware may be executed on a dedicated system or systems, on a personal computer system, on a distributed processing computer system, and/or the like. In some embodiments, logic may be implemented in a stand-alone environment operating on a single computer system and/or logic may be implemented in a networked environment such as a distributed system using multiple computers and/or processors as depicted in FIG. 1, for example.

The host system 12 of the system 10 may include a single processor or multiple processors working together or independently to perform a task. In some embodiments, the host system 12 may be partially or completely network-based or cloud based. The host system 12 may or may not be located in a single physical location. Additionally, multiple host systems 12 may or may not necessarily be located in a single physical location.

In some embodiments, the system 10 may be distributed, and include at least one host system 12 communicating with one or more passenger device 14 via the network 18. As used herein, the terms “network-based,” “cloud-based,” and any variations thereof, are intended to include the provision of configurable computational resources on demand via interfacing with a computer and/or computer network, with software and/or data at least partially located on a computer and/or computer network.

In some embodiments, the network 18 may be the Internet and/or other network. For example, if the network 18 is the Internet, a primary user interface of the system 10 may be delivered through a series of web pages or private internal web pages of a company or corporation, which may be written in hypertext markup language. It should be noted that the primary user interface of the system 10 may be another type of interface including, but not limited to, a Windows-based application, a tablet-based application, a mobile web interface, and/or the like.

The host system 12 may be configured to interface and/or communicate with the passenger device 14, the autonomous vehicle device 16, and the external system 19 via the network 18. For example, the host system 12 may be configured to interface by exchanging signals (e.g., analog, digital, optical, and/or the like) via one or more ports (e.g., physical ports or virtual ports) using a network protocol, for example. Additionally, each host system 12 may be configured to interface and/or communicate with other host systems 12 directly and/or via the network 18, such as by exchanging signals (e.g., analog, digital, optical, and/or the like) via one or more ports.

The network 18 may permit bi-directional communication of information and/or data between the host system 12, the passenger device 14, the autonomous vehicle device 16, and/or the external system 19. The network 18 may interface with the host system 12, the passenger device 14, the autonomous vehicle device 16, and/or the external system 19 in a variety of ways. For example, in some embodiments, the network 18 may interface by optical and/or electronic interfaces, and/or may use a plurality of network topographies and/or protocols including, but not limited to, Ethernet, TCP/IP, circuit switched path, combinations thereof, and/or the like. For example, in some embodiments, the network 18 may be implemented as the World Wide Web (or Internet), a local area network (LAN), a wide area network (WAN), a metropolitan network, a 4G network, a 5G network, a satellite network, a radio network, an optical network, a cable network, a public switch telephone network, an Ethernet network, combinations thereof, and the like, for example. Additionally, the network 18 may use a variety of network protocols to permit bi-directional interface and/or communication of data and/or information between the host system 12, the passenger device 14, the autonomous vehicle device 16, and/or the external system 19.

The network 18 may be almost any type of network. For example, in some embodiments, the network 18 may be a version of an Internet network (e.g., exist in a TCP/IP-based network). It is conceivable that in the near future, embodiments within the present disclosure may use more advanced networking technologies.

In some embodiments, the external system 19 may optionally communicate with the host system 12. For example, in one embodiment of the system 10, the external system 19 may supply data transmissions via the network 18 to the host system 12 regarding real-time or substantially real-time events (e.g., autonomous vehicle itinerary updates and/or autonomous vehicle rideshare privilege updates, as discussed below). Data transmission may be through any type of communication including, but not limited to, speech, visuals, signals, textual, and/or the like. Events may include, for example, data transmissions regarding autonomous vehicle itinerary updates, or, for example, data transmission regarding an autonomous vehicle's authority to accept a rideshare request, initiated via the external system 19.

As described herein, the passenger device 14 and the autonomous vehicle device 16 may be implemented as similar devices, with the exception that the passenger device 14 may be portable and may be carried by the passenger, and the autonomous vehicle device 16 may be integrated into the autonomous vehicle. However, in some embodiments, the autonomous vehicle device 16 is not integrated into the autonomous vehicle, but may be associated with, and in communication with, the autonomous vehicle.

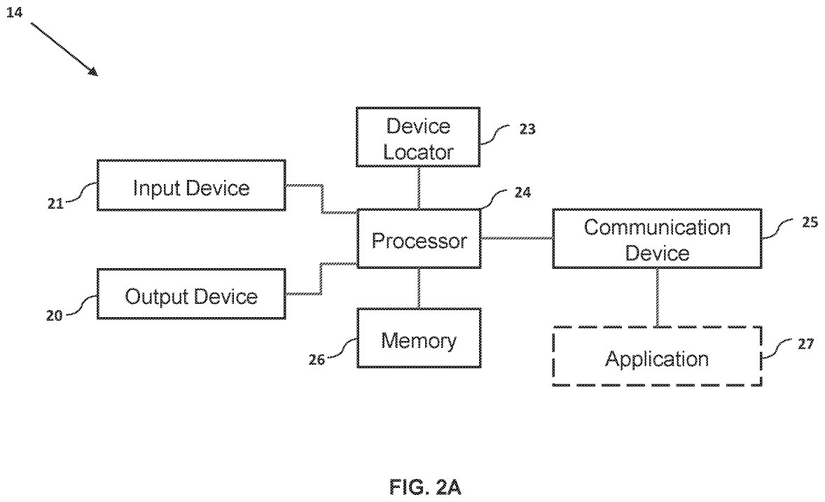

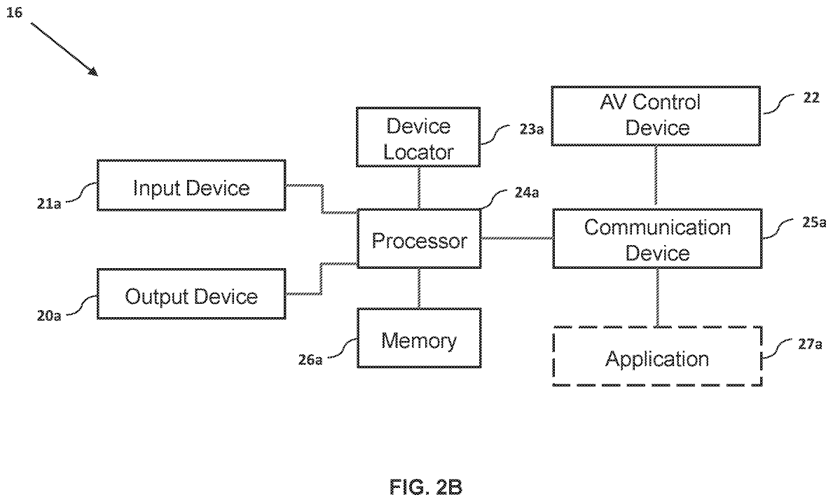

Referring now to FIG. 2A, shown therein is a diagrammatic view of the passenger device 14 for use in the system 10 of FIG. 1 constructed in accordance with the present disclosure. Generally, the passenger device 14 may be utilized for connecting a passenger and an available autonomous vehicle illustrated in FIG. 1. As shown in FIG. 2A, the passenger device 14 of the system 10 may include, but is not limited to, implementation as a personal computer, a cellular telephone, a smart phone, a tablet, a laptop computer, a desktop computer, a network-capable handheld device, a server, a wearable network-capable device, and/or the like.

In some embodiments, the passenger device 14 may include one or more output devices 20 (hereinafter “output device 20”), one or more input devices 21 (hereinafter “input device 21”), a device locator 23, one or more processors 24 (hereinafter “processor 24”), one or more communication devices 25 (hereinafter “communication device 25”) capable of interfacing with the network 18, one or more memory 26 (hereinafter “memory 26”) storing processor-executable code and/or software application(s), for example including, a web browser capable of accessing a website and/or an application 27 capable of communicating information and/or data over a wireless or wired network (e.g., network 18), and/or the like.

The memory 26 may comprise a non-transitory processor-readable medium storing processor-executable instructions, such as the application 27, that, when executed by the processor 24 causes the processor 24 of the passenger device 14 to automatically and without user intervention collect predefined pick-up location information based on the user's current location as determined by the device locator 23 to allow the user to quickly and accurately select a pick-up point location and track the rideshare progress as the passenger travels to the drop-off point location. The pick-up point location may be identified with one or more location data. In one embodiment, the pick-up point location may be a location near a position of the passenger device 14.

The device locator 23 may be configured to determine the position of the passenger device 14. For example, implementations of the device locator 23 may include, but are not limited to, a Global Positioning System (GPS) chip, software based device triangulation methods, network-based location methods such as cell tower triangulation or trilateration, the use of known-location wireless local area network (WLAN) access points using the practice known as “wardriving”, a hybrid positioning system combining two or more of the technologies listed above, or any future developed system or method of locating a device such as the passenger device 14 to provide the position of the passenger device 14.

The input device 21 may be configured to receive information input from the passenger 15 and/or processor 24, and transmit such information to other components of the passenger device 14, the autonomous vehicle device 16, and/or the network 18. The input device 21 may include, but is not limited to, implementation as a keyboard, touchscreen, mouse, trackball, microphone, slide-out keyboard, flip-out keyboard, cell phone, PDA, remote control, fax machine, wearable communication device, network interface, combinations thereof, and/or the like, for example.

The output device 20 may be capable of outputting information in a form perceivable by the passenger 15 and/or processor 24. For example, implementations of the output device 20 may include, but are not limited to, a computer monitor, a screen, a touchscreen, a speaker, a website, a television set, a smart phone, a PDA, a cell phone, a printer, a laptop computer, combinations thereof, and/or the like. It is to be understood that in some exemplary embodiments, the input device 21 and the output device 20 may be implemented as a single device, such as, for example, a touchscreen of a computer, a tablet, or a smartphone. It is to be further understood that as used herein the term user is not limited to a human being, and may comprise, a computer, a server, a website, a processor, a network interface, a human, a user terminal, a virtual computer, combinations thereof, and/or the like, for example.

Referring now to FIG. 2B, shown therein is a block diagram of an exemplary embodiment of the autonomous vehicle device 16 of FIG. 1 constructed in accordance with the present disclosure. In some embodiments, the autonomous vehicle device 16 is associated with an autonomous vehicle and may include one or more output devices 20a (hereinafter “output device 20a”), one or more input devices 21a (hereinafter “input device 21a”), one or more processors 24a (hereinafter “processor 24a”), one or more communication devices 25a (hereinafter “communication device 25a”) capable of interfacing with the network 18, an autonomous vehicle control device 22 (hereinafter “AV control device 22”), and one or more memory 26a (hereinafter “memory 26a”) storing processor-executable instructions/code and/or software application(s), for example including, a web browser capable of accessing a website and/or an application 27a capable of communicating information and/or data over a wireless or wired network (e.g., network 18), and/or the like. In some implementations, the autonomous vehicle device 16 may comprise a device locator 23a.

The memory 26a of the autonomous vehicle device 16 may be a non-transitory processor-readable medium storing processor-executable instructions, such as the application 27a that, when executed by the processor 24a causes the processor 24a of the autonomous vehicle device 16 to automatically and without user intervention collect pick-up location information, interface with the passenger device 14 to permit access into the autonomous vehicle via authorizing the AV control device 22 to unlock a door lock on the autonomous vehicle, receive passenger instructions during the rideshare, and track the rideshare progress as the autonomous vehicle and the passenger travel to the drop-off point location. The pick-up point location and the drop-off point location may be identified with a location data.

The device locator 23a of the autonomous vehicle device 16 may be configured to determine a position of the autonomous vehicle device 16, and therefore the autonomous vehicle associated with the autonomous vehicle device 16. For example, implementations of the device locator 23a may include, but are not limited to, a Global Positioning System (GPS) chip, software-based device triangulation methods, network-based location methods such as cell tower triangulation or trilateration, the use of known-location wireless local area network (WLAN) access points using the practice known as “wardriving”, a hybrid positioning system combining two or more of the technologies listed above.

In some implementations, the device locator 23a may be a component of the autonomous vehicle associated with the autonomous vehicle device 16 and the autonomous vehicle device 16 may obtain and/or receive position information indicative of position (past or present) of the autonomous vehicle from the device locator 23a. The autonomous vehicle device 16 may communicate with the device locator 23a via the AV control device 22, for example.

The input device 21a may be configured to receive information input from a user, the passenger and/or processor 24a, and transmit such information to other components of the autonomous vehicle device 16, the passenger device 14, and/or the network 18. The input device 21a may include, but are not limited to, implementation as a keyboard, touchscreen, mouse, trackball, microphone, slide-out keyboard, flip-out keyboard, cell phone, PDA, remote control, fax machine, wearable communication device, network interface, combinations thereof, and/or the like, for example.

The output device 20a may be capable of outputting information in a form perceivable by the passenger, user and/or processor 24. For example, implementations of the output device 20 may include, but are not limited to, a computer monitor, a screen, a touchscreen, a speaker, a printer, or combinations thereof, and/or the like. It is to be understood that in some exemplary embodiments, the input device 21a and the output device 20a may be implemented as a single device, such as, for example, a touchscreen of a computer, a tablet, or a smartphone. It is to be further understood that as used herein the term user is not limited to a human being, and may comprise, a computer, a server, a website, a processor, a network interface, a human, a user terminal, a virtual computer, combinations thereof, and/or the like, for example.

The AV control device 22 may interface with electrical components of the autonomous vehicle associated with the autonomous vehicle device 16 and may manage and/or control various vehicle-related operations such as, for example, the vehicle door lock system. The AV control device 22 may be implemented as one or more integrated circuits or circuitry, and may include a receiver and a transmitter having any suitable combination of hardware for performing wireless communications with the passenger device 14, and having a controller circuitry communicatively coupled to one or more electrical component of the autonomous vehicle. In one embodiment, the receiver and the transmitter may be integrated into a single circuitry (e.g., communication circuitry), such as, for example, as a WIFI module, a Bluetooth module, an NFC module, and/or an RF module. In one embodiment, the communication circuitry provides a wireless communication channel that permits communication between the passenger device 14 and the AV control device 22 within a predetermined range. The controller circuitry may be configured to transmit one or more signal to control vehicle-related operations. For example, the controller circuitry may be configured to transmit a first signal to the vehicle door lock system to unlock the doors of the autonomous vehicle and a second signal to the vehicle door lock system to lock the doors of the autonomous vehicle. In one embodiment, the communication circuitry of the AV control device 22 may be the communication device 25a of the autonomous vehicle device 16.

In one embodiment, the AV control device 22 is communicatively coupled to the autonomous vehicle and operable to prevent the autonomous vehicle from continuing along the autonomous vehicle itinerary. For example, the processor 24a may receive a pick-up signal from the host system 12. The processor 24a the cause the AV control device 22 to send a first control signal to the autonomous vehicle to cause the autonomous vehicle to stay at a particular pick-up location for a predetermined period of time (as discussed below). Once confirmed that the passenger is in the autonomous vehicle, the host system 12 may sent a continue signal to the processor 24a, which, in turn, may send a second control signal to the autonomous vehicle to cause the autonomous vehicle to continue with the autonomous vehicle itinerary.

In one embodiment, the AV control device 22 is communicatively coupled to the autonomous vehicle via the OBD2 port to receive operational data from the autonomous vehicle. In another embodiment, the AV control device 22 is communicatively couple to the autonomous vehicle via an on-board computer of the autonomous vehicle. The AV control device 22 may be coupled to the on-board computer based on an interface provided by the on-board computer. For example, if the on-board computer provides the interface being an API, the AV control device 22 may be coupled to the on-board computer by passing one or more command via the API, such as an HTML request, or other proprietary request. If the on-board computer provides the interface being an I2C or SPI interface, then the AV control device 22 may be coupled to the on-board computer by implementing an I2C or SPI protocol with the I2C or SPI interface, respectively. Alternatively, the on-board computer may provide the interface being a messaging interface such as by implementing gRPC, in which case, the AV control device 22 may communicate with the autonomous vehicle via the gRPC interface. Alternative interface construction may also be used to provide communication and/or authentication of communication between the AV control device 22 and the autonomous vehicle.

In one embodiment, when the passenger device 14 and the AV control device 22 are moved within the predetermined range of one another, the passenger device 14 may transmit, via the output device 20 or the communication device 25, control information indicative of a first request to unlock the doors of the autonomous vehicle to the AV control device 22. The transmitted control information may be received by the communication circuitry of the AV control device 22, and the AV control device 22 may cause the controller circuitry to transmit the first signal to the vehicle door lock system to unlock the doors of the autonomous vehicle.

In another embodiment, when the passenger device 14 and the AV control device 22 are moved within the predetermined range of one another, the passenger device 14 may transmit, via the output device 20 or the communication device 25, control information indicative of a second request to lock the doors of the autonomous vehicle to the AV control device 22. The transmitted control information may be received by the communication circuitry of the AV control device 22, and the AV control device 22 may cause the controller circuitry to transmit the second signal to the vehicle door lock system to lock the doors of the autonomous vehicle.

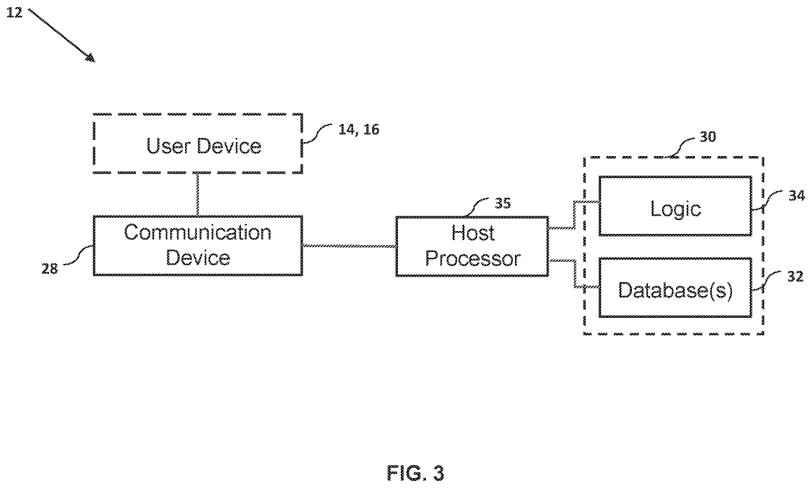

Referring now to FIG. 3, shown therein is a diagrammatic view of an exemplary embodiment of the host system 12 constructed in accordance with the present disclosure. In the illustrated embodiment, the host system 12 is provided with one or more communication devices 28 (hereinafter “communication device 28”), one or more non-transitory processor-readable medium 30 (hereinafter “host memory 30”) storing one or more databases 32 (hereinafter “database 32”) and program logic 34, e.g., processor-executable code, and one or more host processors 35 (hereinafter “host processor 35”). Data requests from the application 27 of the passenger device 14, or the application 27a from the autonomous vehicle device 16, via the communication device 28 are processed by the host processor 35 executing the program logic 34, organized by the host processor 35 into the database 32 and stored, optionally, permanently, in the host memory 30. The program logic 34 and the database 32 are stored in the host memory 30, which may comprise one or more non-transitory processor-readable medium accessible by the host processor 35 of the host system 12.

It should be noted that as used herein, the program logic 34 includes instructions which can be executed by the processor 24 or the host processor 35. The database 32 can be a relational database or a non-relational database. Examples of such databases comprise, DB2®, Microsoft® Access, Microsoft® SQL Server, Oracle®, MySQL, PostgreSQL, MongoDB, Apache Cassandra, and the like. It should be understood that these examples have been provided for the purposes of illustration only and should not be construed as limiting the presently disclosed inventive concepts. The database 32 can be centralized or distributed across multiple host memories 30.

In some embodiments, the host system 12 may comprise the one or more host processor 35 working together, or independently to, execute processor-executable code stored in the host memory 30. Additionally, each host system 12 may include at least one communication device 28 configured to interface with the application 27 of the passenger device 14, and the application 27a of the autonomous vehicle device 16, via network 18. Each element of the host system 12 may be partially or completely network-based or cloud-based, and may or may not be located in a single physical location.

The host processor 35 may be implemented as a single processor or multiple processors working together, or independently, to execute the program logic 34 as described herein. It is to be understood, that in certain embodiments using more than one host processor 35, the host processors 35 may be located remotely from one another, located in the same location, or comprising a unitary multi-core processor. The host processor 35 may be capable of reading and/or executing processor executable code and/or capable of creating, manipulating, retrieving, altering, and/or storing data structures into the host memory 30.

Exemplary embodiments of the host processor 35 may be include, but are not limited to, a digital signal processor (DSP), a central processing unit (CPU), a field programmable gate array (FPGA), a microprocessor, a multi-core processor, combinations, thereof, and/or the like, for example. The host processor 35 may be capable of communicating with the host memory 30 via a path (e.g., data bus). The host processor 35 may further be capable of communicating with the communication device 28 via the path, such as the data bus.

The host processor 35 may be further configured to interface and/or communicate with the passenger device 14, the autonomous vehicle device 16, and/or the external system 19 via the network 18. For example, the host processor 35 may be configured to control the communication device 28 and cause the communication device 28 to communicate via the network 18 by exchanging signals (e.g., analog, digital, optical, and/or the like) via one or more ports (e.g., physical or virtual ports) using a network protocol to provide updated information to the application 27 executed on the passenger device 14 or the application 27a executed on the autonomous vehicle device 16 such as, for instance, real-time location updates for a passenger travelling to a drop-off point location as will be discussed in further detail herein.

The host memory 30 may store processor-executable code such as the program logic 34 and the database 32, and may be implemented as a non-transitory memory, such as for example, random access memory (RAM), CD-ROM, a hard drive, a solid-state drive, an NVMe drive, a flash drive, a memory card, a DVD-ROM, a disk, an optical drive, a magnetic drive, combinations thereof, and/or the like. In some embodiments, the processor executable code may be stored as a data structure, such as the database 32 and/or data table, for example, or in a non-data structure format such as in a non-compiled text file.

In some embodiments, the host memory 30 may be located in the same physical location as the host system 12, and/or the host memory 30 may be located remotely from the host system 12. For example, the host memory 30 may be located remotely from the host system 12 and communicate with the host processor 35 via the network 18. Additionally, when more than one host memory 30 is used, a first host memory 30 may be located in the same physical location as the host processor 35, and an additional host memory 30 may be located in a location physically remote from the host processor 35. Additionally, the host memory 30 may be implemented as a “cloud” non-transitory processor-readable storage memory (i.e., one or more host memory 30 may be partially or completely based on or accessed using the network 18).

The communication device 28 of the host system 12 may transmit data to the host processor 35 and may be constructed similar to the communication device 25 of the passenger device 14 and the communication device 25a of the autonomous vehicle device 16. The communication device 28 may be located in the same physical location as the host processor 35.

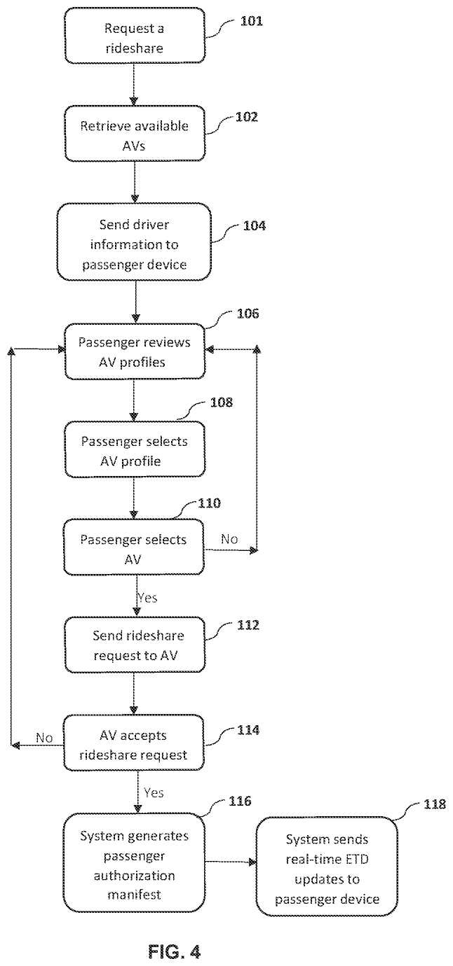

Referring now to FIG. 4, shown therein is a flow diagram of an exemplary embodiment of a rideshare process 100 constructed in accordance with the present disclosure. The rideshare process 100 may include operation of the application 27 for a user who is a passenger, for example. At a step 101 the processor 24 executing the application 27 transmits a rideshare request to the host system 12 via the communication device 25 and the network 18. The rideshare request from the processor 24 of the passenger device 14 may be received by the host processor 35 of the host system 12 via the communication device 28 in communication with the network 18. The rideshare request may include, for example, a passenger profile data that identifies a passenger requesting the rideshare (i.e., passenger identification data), a passenger location (e.g., passenger location data such as latitude/longitude), a pick-up point location data, a drop-off point location data, and a passenger information, including passenger preferences (i.e., passenger preference data).

The passenger identification data of the passenger profile data may be passenger information that is associated with the passenger 15 that is logged into the application 27 on the passenger device 14. The passenger data may be stored locally on the passenger device 14 and/or may be stored on the host system 12 in the host memory 30 such as in the database 32, for instance, and accessed over the network 18. The passenger profile data may include, for instance, a passenger name, a passenger contact information (such as a passenger phone number and a passenger email address), and/or other personally identifiable information to allow an autonomous vehicle and/or associated motor carrier authority to contact the passenger 15. In one embodiment, the autonomous vehicle and/or associated motor carrier authority may contact the passenger 15 after the rideshare request has been received.

In one embodiment, the passenger location data may be captured in real-time by the device locator 23 of the passenger device 14 upon initiation of the rideshare request by the passenger 15 interacting with the input device 21. The application 27 may include instructions that cause the processor 24 to access the location data being generated by the device locator 23.

In one embodiment, the processor 24 may access the location data only when authorized, e.g., only when the passenger 15 has provided prior authorization to access the location data. For example, the application 27 may include instructions that authorize the processor 24 to access the location data: 1) while the application 27 is open and/or being executed by the processor 24 on the passenger device 14; 2) when the user selects an option with the input device 21 that requires the processor 24 executing the application 27 to access the location data; or 3) the application 27 may include instructions that, when executed by the processor 24, requires user authorization (i.e., passenger authorization) from the input device 21 when location data is required. It should be noted that the application 27 may include instructions that when executed by the processor 24 may allow access to the location data in other schemes so long as the location data is only transmitted upon authorization by the user/passenger.

In one embodiment, the pick-up location data may be obtained by the processor 24 from the host processor 35 of the host system 12. For example, the processor 24 may execute the application 27 and send the location data generated by the device locator 23 to the host system 12 via the network 18. In this embodiment, the host processor 35 of the host system 12 is programmed (e.g., by the program logic 34) to match the location data with an authorized pick-up location which may be stored in the host memory 30, for instance, in the database 32 on the host system 12. In some embodiments, a list of authorized pick-up locations may include only pre-authorized pick-up locations, e.g., truck stops or other locations easily accessible from a highway by a class 8 vehicle. The authorized pick-up locations may be identified with location data. Once the host processor 35 of the host system 12 has located an authorized pick-up location matching the location data, the host processor 35 of the host system 12 may be programmed to send the pick-up location data having the authorized pick-up location to the processor 24 of the passenger device 14 via the network 18 and the communication device 28. In such an embodiment, the application 27 may include instructions to cause the processor 24 to show the pick-up location data to the passenger 15, e.g., via the output device 20, in such a way that the passenger 15 may verify that the pick-up location data is for a desired pick-up location. For example, the processor 24 may cause a pin representing the authorized pick-up location of the pick-up location data to be provided on a map displayed on the output device 20.

In an instance where the host processor 35 of the host system 12 is unable to match a pick-up location data with an authorized pick-up location, the application 27 may include instructions to cause the processor 24 to allow the passenger 15 to manually enter information about their desired pick-up location using the input device 21 such as by entering a physical address, cross-streets, a city, a zip code, or other location information which, when sent to the host system 12 will enable the host processor 35 of the host system 12 to match the pick-up location data to an authorized pick-up location.

Similarly, in one embodiment, the drop-off location data may be obtained by the processor 24 executing the application 27 by allowing the passenger 15 to manually enter location information of the drop-off location using the input device 21 to cause the processor 24 to send the location information to the host system 12 via the network 18. In this embodiment, the passenger 15 may enter, for example, a physical address, cross-streets, a city, a zip code, or other information which, when sent to the host system 12, will allow the host processor 35 of the host system 12 to utilize the drop-off location data. The host processor 35 of the host system 12 executing the program logic 34 may be programmed to match the drop-off location data with an authorized drop-off location, e.g., truck stops, which may be stored in the host memory 30, for instance in the database 32 on the host system 12. Once the host processor 35 of the host system 12 has located an authorized drop-off location matching the drop-off location data, the host processor 35 of the host system 12 may be programmed to send the authorized drop-off location to the processor 24 of the passenger device 14 via the network 18 and the communication device 28. In such an embodiment, the application 27 may include instructions that when executed by the processor 24 may cause the processor 24 to show the authorized drop-off location to the passenger 15, e.g., via the output device 20, in such a way that the passenger 15 may verify the authorized drop-off location data a desired drop-off location. For example, the processor 24 a pin representing the authorized drop-off location to be provided on a map displayed on the output device 20.

In one embodiment, the list of authorized drop-off locations may be similar to the list of authorized pick-up locations. The list of authorized drop-off locations may include only pre-authorized locations, such as truck stops which are easily accessible by a class 8 vehicle from a highway. Pre-authorization may include authorization from the owner/operator of the host system 12, and/or the owner/operator of a particular location prior to the particular location being listed as an authorized pick-up or drop-off location. In other embodiments, the list of authorized drop-off locations also includes the list of authorized pick-up locations. As used herein, a highway includes an interstate highway, a state highway, and/or the like.

In one embodiment, the passenger preference data may be obtained by the processor 24 by allowing a passenger 15 to manually select preference options from a predefined list of preferences using the input device 21 of the passenger device 14 and may be sent by the processor 24 to the host system 12 via the network 18. In this embodiment, the passenger 15 may select preferences (e.g., passenger preference data) regarding one or more autonomous vehicle property, for example, whether the autonomous vehicle is equipped with air conditioning, an audio system, or a sleeping cab. The one or more autonomous vehicle property may include features that may not typically be included in autonomous vehicles, such as in self-driving class 8 vehicles, that are intended to be operated without a driver or a passenger. In one embodiment, the passenger 15 may provide a response to a first predetermined set of questions indicative of a passenger preference to generate the passenger preference data. In this embodiment, the passenger preference data may comprise responses to the first predetermined set of questions.

In some embodiments, the autonomous vehicle may be accompanied by a driver (an accompanying driver 17, FIG. 1) qualified to operate the autonomous vehicle in a manual-mode, for example, in case of emergency. The passenger 15 may select preferences (e.g., passenger preference data) regarding accompanying driver preference data, for example, whether the accompanying driver 17 would listen to music, how much conversation the passenger 15 would like to have with the accompanying driver 17, whether the accompanying driver 17 takes frequent breaks (such as bathroom breaks, bio-breaks, or stretch breaks), an expected duration of each break, a temperature the accompanying driver 17 maintains in the autonomous vehicle, whether the accompanying driver 17 smokes inside or outside of the autonomous vehicle, or whether the accompanying driver 17 travels with a pet, and/or the like. In one embodiment, the accompanying driver 17 may provide a response to a second predetermined set of questions indicative of an accompanying driver preference to generate the accompanying driver preference data. In this embodiment, the accompanying driver preference data may comprise responses to the second predetermined set of questions.

In this embodiment, the host processor 35 of the host system 12 is programmed to match the passenger preference data with the accompanying driver preference data, which may be similarly obtained from the accompanying driver 17 via the autonomous vehicle device 16). The accompanying driver preference data may be stored in the host memory 30, for example, in the database 32 on the host system 12. In some embodiments, the host processor 35 of the host system 12 will compare the passenger preference data with the accompanying driver preference data to calculate a match score that correlates a quantity of passenger preferences met by a particular accompanying driver 17 and/or an autonomous vehicle. In such an embodiment, the processor 24 executing the application 27 may be programmed to show the match score to the passenger 15, such as via the output device 20. The passenger 15 may verify whether the passenger 15 would like to travel with the accompanying driver 17 or in the particular autonomous vehicle. For example, a percentage score representing the match score can be provided and displayed on the output device 20.

At a step 102, the host processor 35 of the host system 12 may retrieve a set of potential autonomous vehicles from the host memory 30, such as from the database 32 stored on the host memory 30 of the host system 12. Each potential autonomous vehicle may be an autonomous vehicle having an autonomous vehicle itinerary (e.g., a trip itinerary) including the desired pick-up location and the desired drop-off location. In one embodiment, the autonomous vehicle itinerary (e.g., the trip itinerary) may include one or more of: an autonomous vehicle identifier (that may be unique to each autonomous vehicle), at least one pick-up region having an estimate time (of arrival and/or of departure), a final destination, a delivery deadline (e.g., a time or timeframe at which the autonomous vehicle is expected at the final destination), and a path or route.

In one embodiment, the autonomous vehicle itinerary may include a load pick-up location, a pick-up region, a drop-off region, a final destination, and a route. The autonomous vehicle itinerary may include an expected time of arrival at the pick-up region and/or an expected time of arrival at the drop off region. The load pick-up location may be a city, zip code or the like indicative of where the autonomous vehicle will begin the route to the final destination. The pick-up region may be a city or pick-up location along the route. The drop-off region can also be a city or drop-off location along the route. The host processor 35 of the host system 12 may also retrieve the autonomous vehicle itinerary from the external system 19.

In one embodiment, the host processor 35 may be programmed to determine the availability of an autonomous vehicle after determining not only whether an autonomous vehicle itinerary matches the rideshare request, but also by confirming an autonomous vehicle's authority to accept the rideshare request by retrieving and analyzing an autonomous vehicle's privileges from the external system 19.

To keep the autonomous vehicle itinerary of the autonomous vehicles current, the host processor 35 of the host system 12 may be programmed to obtain and/or receive a current location, a current velocity, etc. of the autonomous vehicle from the autonomous vehicle device 16, to determine whether the autonomous vehicle is operating in accordance with the autonomous vehicle itinerary. For example, the host processor 35 of the host system 12 may ping the autonomous vehicle device 16 on a predetermined, or random, schedule to obtain the current location of the autonomous vehicle device 16. In other embodiments, the processor 34a executing the application 27a on the autonomous vehicle device 16 may include instructions to periodically, or randomly, report a location data (e.g., retrieved from the device locator 23a) to the host system 12.

In one embodiment, the host processor 35 of the host system 12 may monitor the current location and/or current velocity of the autonomous vehicle device 16 and/or the autonomous vehicle. The host processor 35 may utilize one or more locations and/or velocities of the autonomous vehicle device 16 and/or the autonomous vehicle to determine whether the autonomous vehicle associated with the autonomous vehicle device 16 will meet a delivery deadline, e.g., whether the autonomous vehicle device 16 will arrive at the final destination at a predetermined time or within a predetermined timeframe. For example, the host processor 35 may calculate an estimated time of delivery using the velocity and location information and the distance to the final destination from the one or more locations, using known mathematical equations. In some implementations, calculating the estimated time of delivery may further include obtaining and/or receiving, and utilizing, additional data, including one or more of: traffic-conditions data, weather data, emergency-alert data, construction data, road-closure data, maintenance data from the autonomous vehicle, operational data from the autonomous vehicle, and the like. The additional data may be used in the calculation and result in a longer or shorter estimated time of delivery.

If the autonomous vehicle associated with the autonomous vehicle device 16 is behind schedule, or, in some embodiments, on schedule, the host processor 35 may mark that autonomous vehicle device 16 and/or autonomous vehicle as ineligible or otherwise unable to accept the rideshare. In this way, the host processor 35 can ensure that the autonomous vehicle is not operating for a period of time longer than expected in the autonomous vehicle itinerary (thereby causing an increase in expected environmental pollution) and that the autonomous vehicle reaches the final destination without undue delay. If the autonomous vehicle is marked ineligible, the host processor 35 may not select the autonomous vehicle as an available autonomous vehicle in step 102.

In one embodiment, the host processor 35 may use one or more passenger preference to determine whether an autonomous vehicle associated with the autonomous vehicle device 16 is eligible to accept the rideshare request. For example, if the processor 35 determines that the autonomous vehicle has one hour of slack time (i.e., an amount of time between an estimated time of arrival at the final destination and the predetermined delivery deadline), and the passenger preference data indicates that the passenger expects to take two or fewer breaks or stops for the duration of the rideshare, then the processor 35 may determine that the autonomous vehicle associated with the autonomous vehicle device 16 is eligible to accept the rideshare request if each break or stop is expected to last for fifteen minutes or less, that is the duration of the pick-up, the duration of the drop-off, and the duration of the breaks, when combined, are within a threshold of the slack time. In other words, the processor 35 may calculate an expected change in the estimated time of arrival with the rideshare request and compare the expected change to an estimated slack time to determine whether the autonomous vehicle can still make the delivery deadline at the final destination. If the autonomous vehicle is marked eligible, the host processor 35 may select the autonomous vehicle as an available autonomous vehicle in step 102.

In one embodiment, the host processor 35 of the host system 12, receiving the location data for the autonomous vehicle device 16, may store the location data in the host memory 30 (e.g., in the database 32) and may use the location data to determine compliance with the autonomous vehicle itinerary. In some embodiments, reporting of itinerary data from the autonomous vehicle devices 16 to the host system 12 may be performed outside of a pre-determined time. The host processor 35 of the host system 12 may utilize the current location/velocity of the autonomous vehicle to determine whether the autonomous vehicle is available to fulfill the rideshare request.

In another embodiment, the host processor 35 executing the program logic 34 may request autonomous vehicle itinerary data for the autonomous vehicle from the external system 19 at one or more instants of time during a selected time frame, such as, for instance, 8:00 a.m. to 6:00 p.m., local time. The host processor 35 of the host system 12 may then use the autonomous vehicle itinerary data received from the external system 19 to determine whether the autonomous vehicle is available to fulfil the rideshare request.

In (optional) step 104, in an embodiment where the accompanying driver 17 is present with the autonomous vehicle, the host processor 35 of the host system 12 sends a driver information data to the passenger device 14 via the network 18. The driver information data may include an autonomous vehicle profile data and/or an accompanying driver profile data, including the autonomous vehicle itinerary data, and other information regarding the autonomous vehicle and/or accompanying driver, such as a photograph of the accompanying driver 17, a photograph of the autonomous vehicle, information regarding the accompanying driver's professional experience, information regarding the autonomous vehicle (e.g., class 8 vehicle), the accompanying driver preference data, the accompanying driver's authority owner's name and associated motor carrier name and number, and/or the like, or some combination thereof. In one embodiment, the processor 24 executing the application 27 on the passenger device 14 may be programmed to display the driver information data (e.g., the autonomous vehicle and/or accompanying driver profile data) as selectable indicators in the form of an autonomous vehicle profile banner and/or an accompanying driver profile banner on output device 20, as shown in FIG. Band described in more detail below.

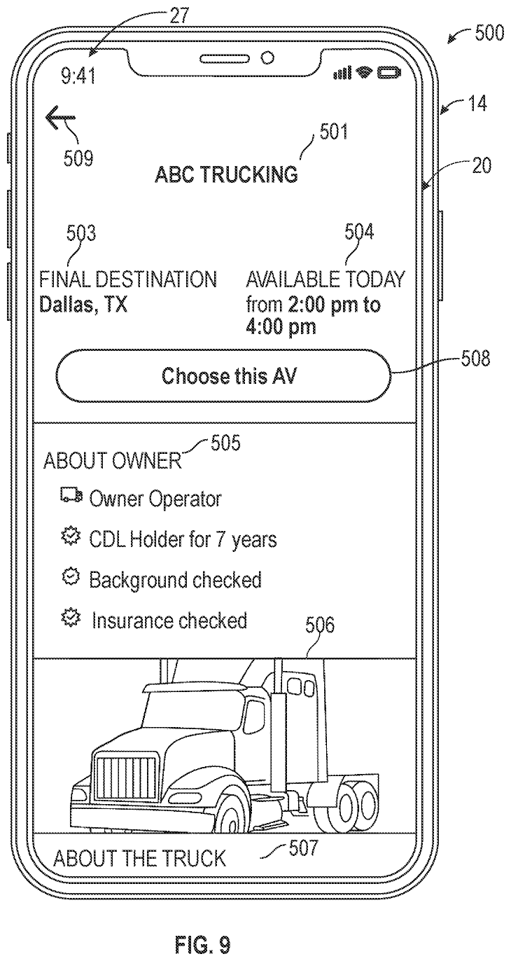

In step 106, the passenger 15 may review a profile of the autonomous vehicle. The passenger 15 may further click, touch, or otherwise select a selectable indicator associated with the desired autonomous vehicle on the output device 20 of the passenger device 14 in step 108. In one embodiment, the processor 24 executing the application 27, may display the autonomous vehicle profile on an autonomous vehicle profile screen 500 on the output device 20 as shown in FIG. 9, which will be described in more detail herein.

At a decision step 110, the processor 24 executing the application 27 may determine if the passenger 15 has selected an autonomous vehicle after reviewing the autonomous vehicle profile. If the passenger has not selected any autonomous vehicle, the processor 24 executing the application 27 may return to step 106 to allow the user to review additional autonomous vehicle profiles until the passenger 15 selects an autonomous vehicle.

At decision step 110, if the passenger has selected an autonomous vehicle the processor 24 executing the application 27 may continue to step 112 where the processor 24 may send the rideshare request to the autonomous vehicle device 16 associated with the selected autonomous vehicle via the communication device 25 and the network 18. For example, the processor 24 executing the application 27 may send the passenger profile data, including identification data, passenger location data, passenger pick-up point location data and passenger drop-off point location data via the network 18 to the host system 12. The host processor 35 of the host system 12 may be programmed to send the passenger profile data and the rideshare request to the autonomous vehicle device 16 via the network 18. The passenger location data and the passenger pick-up point location data may be different, indicating that the passenger 15 was not at the passenger pick-up point location when the rideshare request was generated.

At decision step 114, an authority for the selected autonomous vehicle profile reviews the passenger profile data and determines whether to accept the rideshare request. In some embodiments, the authority is the accompanying driver 17 (when present) while in other embodiments, the authority is the motor carrier authority. In one embodiment, the authority is the autonomous vehicle device 16. In some embodiments, the motor carrier authority includes a privilege to the autonomous vehicle to be able to accept the rideshare request without review by a human user/operator. In one embodiment, when an authority other than the motor carrier authority accepts the rideshare request, the acceptance is a provisional acceptance.

In some embodiments, the motor carrier authority retains the right to review and approve the rideshare request before a final acceptance of the rideshare request is issued. In this instance, once the rideshare request has a provisional acceptance, the provisional acceptance and the rideshare request is provided to the motor carrier authority for final acceptance. In some embodiments, the host processor 35 of the host system 12 sends a message including the provisional acceptance, the rideshare request, and the identification information of the autonomous vehicle to the motor carrier authority via the external system 19 for final acceptance. Once the rideshare request has the final acceptance, the autonomous vehicle is available to provide transportation services to the passenger 15. In operation, the processor 24a of the autonomous vehicle device 16 may provide a confirmation via the output device 20a and/or the motor carrier authority may enter a confirmation into the external system 19. The processor 24a executing the application 27a may transmit an autonomous vehicle confirmation message from the autonomous vehicle device 16 to the host system 12 via the network 18.

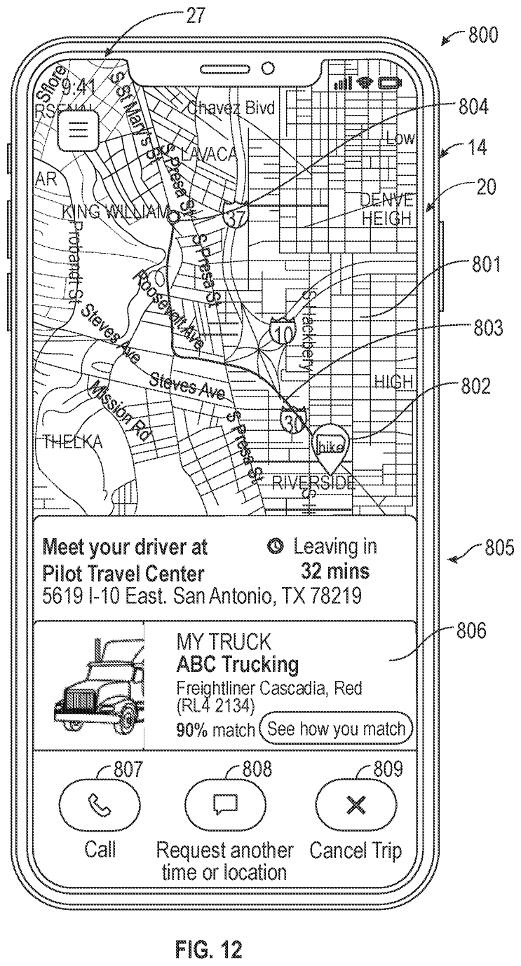

If confirmed, a confirmation message may be presented on the passenger device 14 at a decision step 114. In one embodiment, the processor 24 of the passenger device 14 executing the application 27 may receive one or more real-time location update from the processor 24a of the autonomous vehicle device 16. In such an embodiment, the processor 24a executing the application 27a is programmed to cause the device locator 23a of the autonomous vehicle device 16 to send one or more real-time update of the location information of the autonomous vehicle device 16 to the host system 12 via the communication device 25a and the network 18. The host processor 35 of the host system 12 is programmed to send the location information of the autonomous vehicle device 16 to the passenger device 14 via the network 18 and the communication device 28 thereby updating the passenger 15 as the autonomous vehicle travels to the pick-up point location, as shown in FIG. 12, for example.

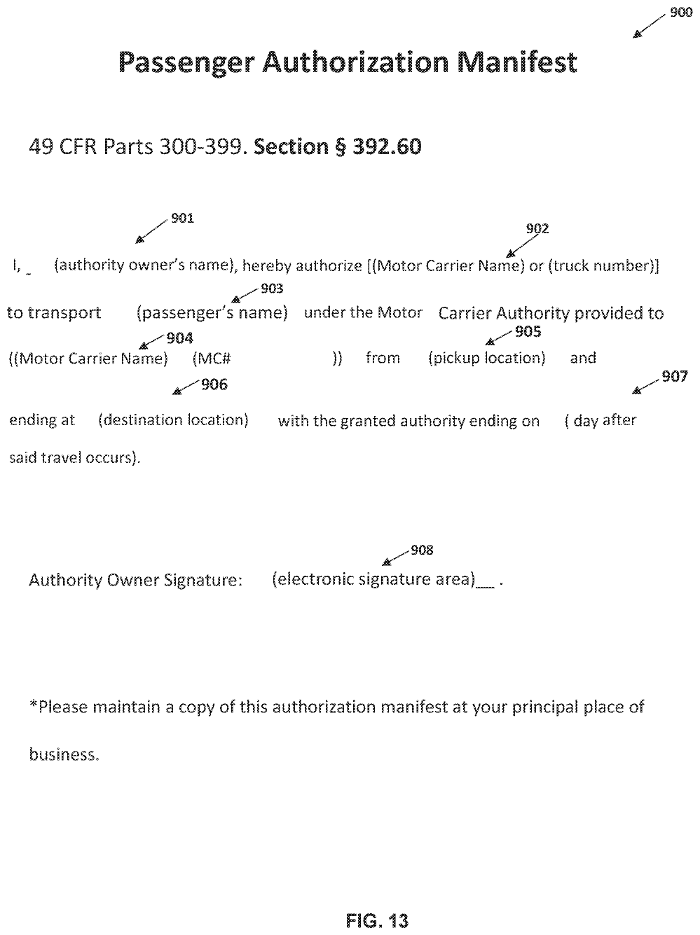

Furthermore, if confirmed, at step 116, the host processor 35 of the host system 12 may generate a passenger authorization manifest. The host processor 35 may store the passenger authorization manifest in the host memory 30 and/or may transmit the passenger authorization manifest to the external system 19. In one embodiment, when the autonomous vehicle and/or motor carrier authority accepts the proposed rideshare request (at decision step 114), the host processor 35 may further generate the passenger authorization manifest 900, as shown in FIG. 13.

If declined or the autonomous vehicle and/or motor carrier authority does not confirm within a predefined time limit, the host processor 35 of the host system 12 may notify the passenger 15 that the rideshare request has not been confirmed. The passenger 15 may then select another autonomous vehicle at step 108. The process may then continue from step 108 as described above.

At step 118, the host processor 35 of the host system 12 collects and sends real-time location updates of the autonomous vehicle device 16 to the passenger device 14. The real-time location updates may be displayed on the passenger device 14 as a visible ETD indicator (e.g., the ETD section 805 of FIG. 12). The processor 24 executing the application 27 may be programmed to calculate and display an estimated time of departure (ETD) so that the passenger 15 is apprised, in real-time, of the time that the autonomous vehicle will depart from the pick-up location. The ETD can be calculated by determining a velocity of the autonomous vehicle device 16 and multiplying the velocity by a distance to the pick-up location plus a predetermined period of time that autonomous vehicle would be required to wait before departing, such as 15 minutes.

Once the autonomous vehicle arrives at the pick-up point location, the host processor 35 of the host system 12 and the processor 24 executing the application 27 may be programmed to handle location services of the passenger device 14 and the autonomous vehicle device 16 in a number of ways. For instance, in one embodiment, the host processor 35 of the host system 12 may be programmed to automatically stop sending real-time ETD updates of the autonomous vehicle device 16 to the passenger device 14 when the host processor 35 of the host system 12 determines that the autonomous vehicle device 16 and the passenger device 14 are within a predetermined distance of one another for a predetermined period of time. In such an embodiment, the predetermined distance may be within a range of between 0 feet and 300 feet and the predetermined period of time may be within a range of between 1 minute and 30 minutes, for example, however other distances and periods of time may be selected, such as, in one embodiment, by passenger preferences.

In other embodiments, the autonomous vehicle may also be fitted with an inward facing live camera. In inward facing live camera may be communicatively coupled to the autonomous vehicle device 16 and may provide information to the host system 12 via the network 18 regarding a presence of the passenger 15 within a cabin of the autonomous vehicle. In another embodiment, an authorized attendant at the pick-up point location may confirm that the passenger 15 has boarded the autonomous vehicle, for example, via the input device 21a of the autonomous vehicle device 16. In one embodiment, the host processor 35 of the host system 12 may be programmed to stop sending real-time ETD updates to the passenger device 14 once the host processor 35 determines that the autonomous vehicle device 16 has reached the pick-up point location.

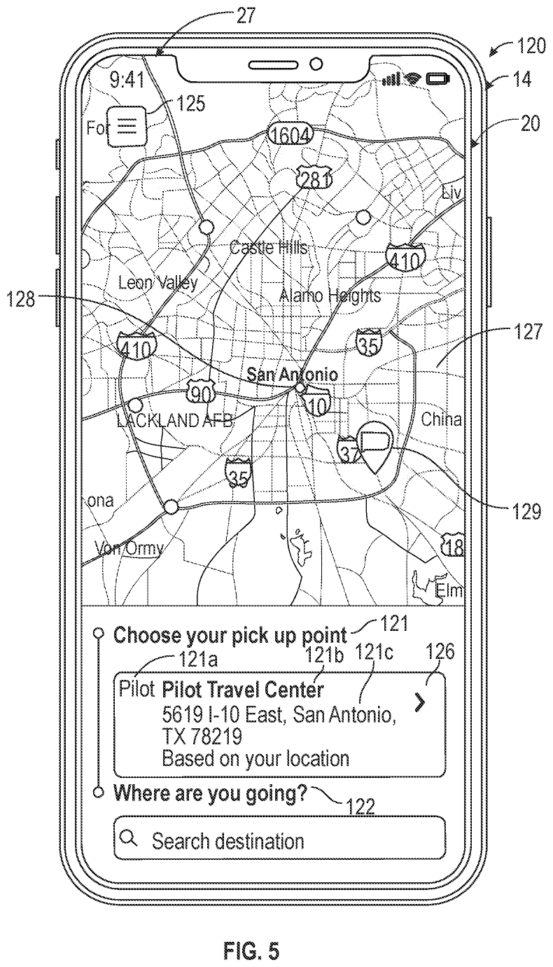

As illustrated in FIGS. 5-12, the system 10 for connecting a passenger and an available autonomous vehicle may include the application 27 executed by the processor 24 of the passenger device 14 that is capable of communicating with the host system 12 via the network 18. The system 10 may include a separate program, application or “app”, or a widget, each of which may correspond to instructions stored in the memory 26 of the passenger device 14 and/or in the memory 26a of the autonomous vehicle device 16 for execution by the processor 24 of the passenger device 14 and/or the processor 24a of the autonomous vehicle device 16. Alternately, the system 10 may include instructions (such as the program logic 34) stored in the host memory 30 of the host system 12 for execution by the host processor 35 of the host system 12 with results sent via the network 18 to be displayed on the output device 20 of the passenger device 14 and/or on the output device 20a of the autonomous vehicle device 16.

The instructions of the application 27, when executed by the processor 24 of the passenger device 14 and/or the instructions of the application 27a, when executed by processor 24a of the autonomous vehicle device 16, may cause the passenger device 14 and/or the autonomous vehicle device 16 to perform certain tasks, respectively. For example, such tasks may include displaying content such as a home screen. The program logic 34 may support both a passenger home screen 120 or an autonomous vehicle/motor carrier authority home screen (not shown), for example, depending on a type of user logging in to the application 27.

Referring now to FIG. 5, shown therein is an exemplary embodiment of a passenger home screen 120 of the application 27 on the output device 20 of the passenger device 14. The passenger home screen 120 may be provided with a pick-up point field 121, a drop-off point field 122, and a menu selectable indicator 125. By selecting the pick-up point field 121, or other suitably assigned or programmed selectable indicator or interactivity option (such as swiping) available on the passenger device 14, the passenger 15 may begin a location capture process to locate authorized pick-up locations by proximity, for instance. Each of these respective selectable indicators allows the passenger 15 to access the various aspects and screens of the application 27.

The instructions of the application 27, when executed by the processor 24 of the passenger device 14, causes the processor 24 to obtain a current location of the passenger device 14 using the device locator 23. The processor 24 is programmed to send a signal indicative of the current location of the passenger device 14 to the host system 12 via the network 18. Upon receipt of the signal, the host processor 35 of the host system 12 may be programmed to match the current location with one or more authorized pick-up point location which may be stored in the host memory 30, for instance, in the database 32 on the host system 12. In some embodiments of the system 10, the list of authorized pick-up point locations may include pre-authorized locations, e.g., truck stops, as described above in more detail. Once the host processor 35 of the host system 12 has located an authorized pick-up point location within a predefined distance of the current location of the passenger device 14, the host processor 35 is programmed to send the pick-up point location information of the authorized pick-up point location to the passenger device 14 via the network 18.

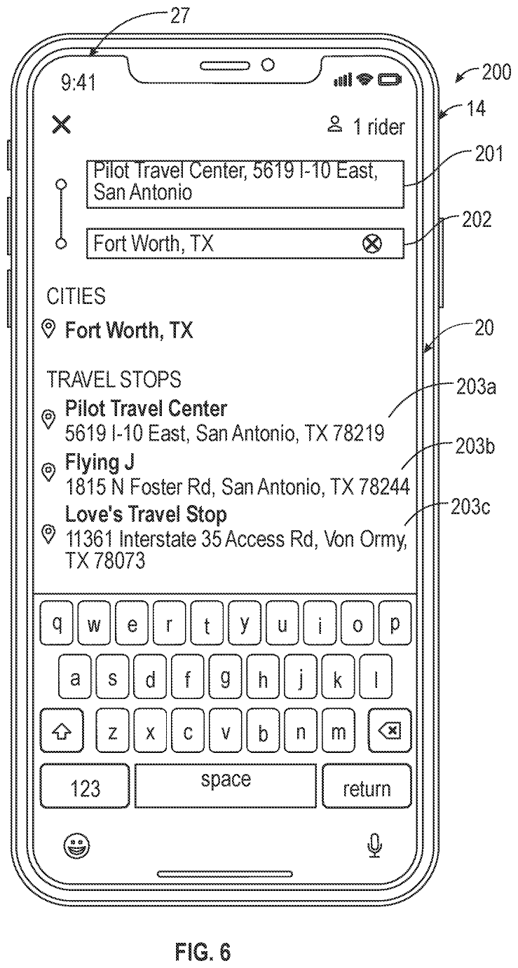

Upon receiving the pick-up point location information, the processor 24 on the passenger device 14 is programmed to display the pick-up point location information on the pick-up point field 121, for instance as shown in FIG. 5. The pick-up point field 121 may be provided with at least one graphic of a logo of the pick-up point location 121a, a name field 121b, and an address field 121c. A visual indicator of the current location of the passenger 15 is provided on map 127 as indicated by marker 128. A visual indicator of the location contained in pick-up point field 121 (e.g., the address field 121c) may be indicated by a marker 129. In one embodiment, the passenger 15 may select appropriately programmed selectable indicators such as a right arrow selectable indicator 126 to cause the processor 24 to display information about a second pick-up location. In this way, the passenger 15 can navigate to different pick-up point locations stored in the host memory 30, e.g., the database 32, for instance. Selecting the right arrow selectable indicator 126, for instance, causes the processor 24 to send a signal to the host system 12 indicating that the passenger 15 would like to see other pick-up point locations. In response to receiving the signal, the host processor 35 of the host system 12 may be programmed to cause the passenger device 14 to display a location selection screen 200, as shown in FIG. 6.

Referring now to FIG. 6, shown therein is an illustration of an exemplary embodiment of the location selection screen 200 constructed in accordance with the present disclosure. Once on the location selection screen 200, the passenger 15 is provided with a location screen pick-up point field 201 on the output device 20 of the passenger device 14. The passenger 15 may manually enter information such as a desired pick-up point location using the input device 21. The information may include, for example, a physical address, cross-streets, a city, a zip code, or other information which will allow the host system 12 to locate the pick-up location data as described above. The passenger 15 is further provided with a drop-off point field 202 on the output device 20. If the passenger 15 prefers the pick-up point location selected by the host processor 35 of the host system 12 based on the current location of the passenger device 14, the passenger 15 can continue to complete a rideshare request by clicking or otherwise selecting the drop-off point field 202.

The passenger 15 may select a drop-off point location by manually entering information about the desired drop-off point location into the drop-off point field 202 using the input device 21. The information about the desired drop-off field may include, for example, a physical address, cross-streets, a city, a zip-code, or other information which will allow the host processor 35 of the host system 12 to locate the drop-off point data. The host processor 35 of the host system 12 may be programmed to match the desired drop-off point location information with a drop-off point location which may be stored in the host memory 30, for instance in the database 32 on the host system 12 as described above.

In some embodiments of the system 10, the list of authorized drop-off point locations may include pre-authorized locations, e.g., truck stops. Once the host system 12 has located a list of authorized drop-off point locations matching the passenger's desired drop-off point location information, the host processor 35 is programmed to send the list of authorized drop-off point location information to the passenger device 14 via the network 18. The list of authorized drop-off point location information may be displayed on the output device 20 of the passenger device 14 as selectable travel stop indicators 203a-c.

When the passenger clicks or otherwise selects a selectable travel stop indicator 203a-c, the processor 24 may be programmed to send information to the host system 12 via the network 18. For instance, the processor 24 may send the location contained in the location screen pick-up point field 201 and the drop-off point location selected by the passenger by clicking on or otherwise selecting a travel stop indicator 203a-c.

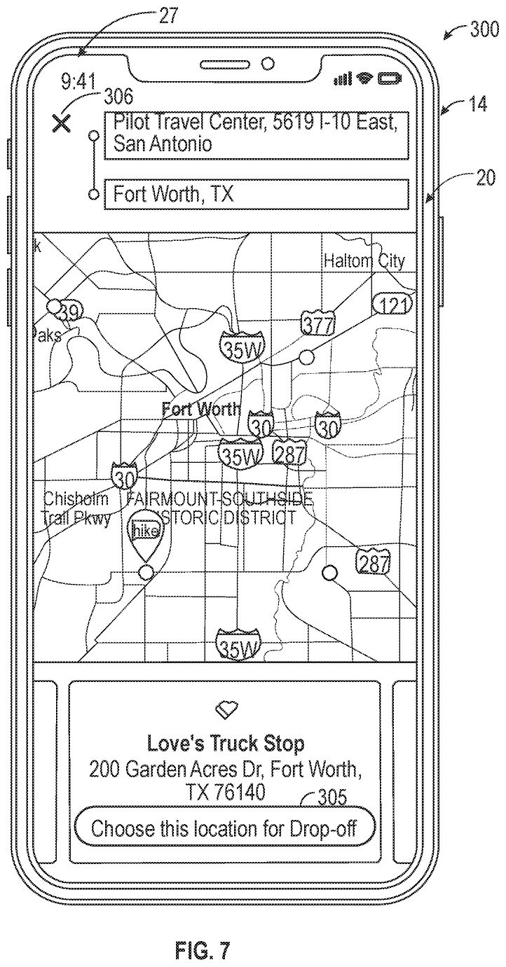

Referring now to FIG. 7, shown therein is an illustration of an exemplary embodiment of a drop-off point selection screen 300 constructed in accordance with the present disclosure. In one embodiment, upon receipt of the pick-up point location and drop-off point location, the host processor 35 of the host system 12 may be programmed to cause the output device 20 of the passenger device 14 to display the drop-off point selection screen 300. Once provided with the drop-off point selection screen 300, the passenger 15 can confirm the drop-off point location selected on the location selection screen 200 by clicking or otherwise selecting a choose this location selectable indicator 305. The passenger can return to the location selection screen 200 by clicking or otherwise selecting a cancel selectable indicator 306. Selection of the cancel selectable indicator 306 will cause the processor 24 executing the application 27 to display the location selection screen 200 on the output device 20 as described above.

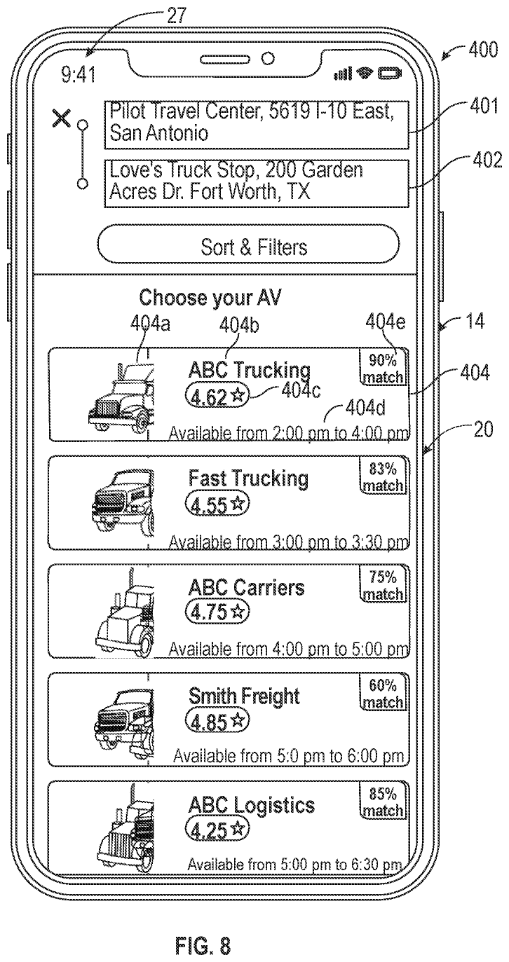

Referring now to FIG. 8, shown therein is an illustration of an exemplary embodiment of an autonomous vehicle selection screen 400 constructed in accordance with the present disclosure. Upon confirmation of the drop-off point location, the host processor 35 of the host system 12 may be programmed to cause the output device 20 of the passenger device 14 to display an autonomous vehicle selection screen 400. The host processor 35 may be programmed to locate autonomous vehicles that are currently active and include both the pick-up point location and the drop-off point location in the autonomous vehicle itinerary as described above in more detail. The pick-up point location may be displayed in a pick-up point location field 401 and the drop-off point location may be displayed in a drop-off point location field 402.

In one embodiment, the host processor 35 may be programmed to locate autonomous vehicles that are currently active by pinging, or otherwise sending a connection signal to the autonomous vehicle devices 16 that have an autonomous vehicle itinerary including the pick-up point location (e.g., the autonomous vehicle device 16 reported being scheduled to make a stop at the location (or pass within a predetermined distance to the location) contained in the pick-up point location field 401. If, for instance, an autonomous vehicle device 16 is not able to respond to the ping sent by the host processor 35 of the host system 12, the host processor 35 will not list that autonomous vehicle device 16 as currently active. Even if an autonomous vehicle is not scheduled to make a stop at the location contained in pick-up point location field 401, the host processor 35 may still list an autonomous vehicle device 16 as currently active if the autonomous vehicle device 16 is within a predetermined distance (e.g., 100 miles) from the location contained in the pick-up point location field 401.

In one embodiment, the host processor 35 may be programmed to locate autonomous vehicles that are within a predetermined distance from the location contained in the pick-up point location field 401 by pinging, or otherwise sending a connection signal to the autonomous vehicle device 16. Likewise, if the autonomous vehicle device 16 is determined to be outside the predetermined distance from the location contained in the pick-up point location field 401, the host system 12 will not list that autonomous vehicle device 16 as currently active. For example, once an autonomous vehicle gets within 100 miles of a region the autonomous vehicle may be travelling through with no plans of stopping, the host system 12 may list the autonomous vehicle as currently active to pick up a passenger. In this instance, the host system 12 may place the autonomous vehicle on the passenger's “available autonomous vehicle list.” If the autonomous vehicle is selected by a passenger, then the autonomous vehicle may be able to pick up the passenger despite having not been provided plans to make a stop in a specific region.

Software for matching geo-locations of pick-up point locations relative to a driver's location are available commercially by companies such as RideShark™, RidePro™, and RideAmigos™. Such software may be used to match geo-locations of pick-up point locations and/or drop off point locations relative to an autonomous vehicle's current location or expected location. The autonomous vehicles' route (e.g., itinerary) can be modeled as a series of geo-locations, which may be time-based indicating an expected location of the autonomous vehicle at particular instances of time. The autonomous vehicle's expected location at a particular instance of time may be entered into the software as the autonomous vehicle's actual location to assist in matching particular autonomous vehicles with particular passengers.

The host processor 35 will then determine whether, of the currently active autonomous vehicles scheduled to pass within a first predetermined distance, or make a stop at the location contained in pick-up point location field 401, each autonomous vehicle is also scheduled to make a stop at, or pass within a second predetermined distance of, the location contained in drop-off point location field 402. Only currently active autonomous vehicles scheduled to make a stop at or pass within the first predetermined distance of the location contained in the pick-up point location field 401 and the second predetermined distance of the location contained in the drop-off point location field 402 will be displayed on the output device 20 of the passenger device 14.

Once the host processor 35 has determined the list of autonomous vehicle devices 16 that are currently active, able to respond to the host processor 35, and are able to stop at both the location contained in pick-up point location field 401 and the location contained in the drop-off point location field 402, the host processor 35 is programmed to send the list of autonomous vehicle devices 16 to the passenger device 14. The processor 24 of the passenger device, executing the application 27 is programmed to display the list of available autonomous vehicles on the output device 20 of the passenger device 14. The list of available autonomous vehicles may be visually displayed on the autonomous vehicle selection screen 400 provided with a selectable indicator, such as an autonomous vehicle banner 404, which may include a picture of the vehicle 404a, an authority owner name 404b, a vehicle rating 404c, a vehicle availability 404d, and a preference match score 404e, as shown in FIG. 8.

In one embodiment, the processor 24 executing the application 27 is programmed to provide the passenger 15 with information about the available autonomous vehicles to aid in the passenger's selection of an autonomous vehicle for the passenger's requested rideshare in the autonomous vehicle selection screen 400. In one embodiment, the passenger 15 may request additional information about the available autonomous vehicle by clicking or otherwise selecting one of the autonomous vehicle banners 404 associated with a particular available autonomous vehicle. Selection of the autonomous vehicles banner 404 causes the processor 24 executing the application 27 to display an autonomous vehicle profile screen 500, as shown in FIG. 9.

Referring now to FIG. 9, shown therein is an illustration of an exemplary embodiment of the autonomous vehicle profile screen 500 constructed in accordance with the present disclosure. It should be noted that the autonomous vehicle profile screen 500 may be a new screen in the application 27. The autonomous vehicle profile screen 500 may be provided with a name of the owner-operator 501, a final destination section 503, an availability section 504, a description of the owner-operator in an accompanying owner-operator information section 505, a picture of the autonomous vehicle 506, a description of the autonomous vehicle in an autonomous vehicle information section 507, a choose this autonomous vehicle selectable indicator 508, and a back selectable indicator 509.

After reviewing the autonomous vehicle information on the autonomous vehicle profile screen 500, the passenger 15 may indicate via the input device 21 a desire to review information about another autonomous vehicle on the list of autonomous vehicles by clicking or otherwise selecting the back selectable indicator 509. Selection of the back selectable indicator 509 will cause the processor 24 executing the application 27 to display the autonomous vehicle selection screen 400 on the output device 20 as described above.

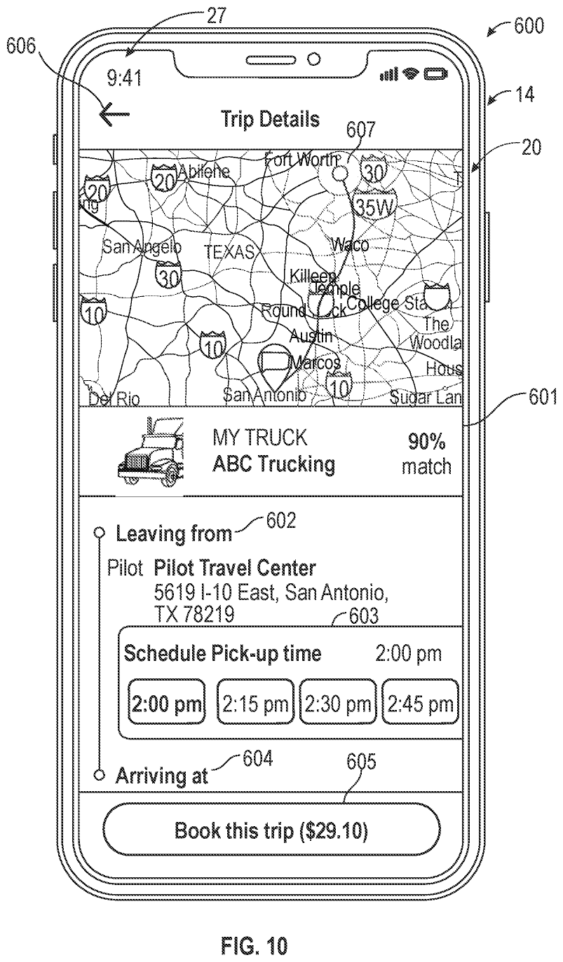

Alternatively, the passenger 15 may indicate a desire to travel in the particular autonomous vehicle by clicking or otherwise selecting the choose this autonomous vehicle selectable indicator 508. Selection of the choose this autonomous vehicle selectable indicator 508 causes the processor 24 executing the application 27 to send a signal to the host system 12 indicating selection of the autonomous vehicle to fulfill the rideshare request. Selection of the choose this autonomous vehicle selectable indicator 508 causes the processor 24 executing the application 27 to display on the output device 20 a passenger scheduling screen 600, as shown in FIG. 10.

Referring now to FIG. 10, shown therein is an illustration of an exemplary embodiment of the passenger scheduling screen 600 constructed in accordance with the present disclosure. It should be noted that the passenger scheduling screen 600 may be a new screen in the application 27. The passenger scheduling screen 600 may be provided with a selectable indicator, such as an autonomous vehicle selection banner 601, a leaving from section 602, a scheduling section 603, an arriving at section 604, a book this trip selectable indicator 605, and a back selectable indicator 606. The scheduling section 603 provides the passenger 15 the ability to select a departure time from a plurality of departure times that may vary by a predetermined increment, such as every 15 minutes. The passenger 15 may indicate at what time the passenger 15 would like to depart from the location contained in the leaving from section 602 by selecting, via the input device 21, a departure time from the plurality of departure times in the scheduling section 603. Selection of a departure time in the scheduling section 603 causes the processor 24 executing the application 27 to send a signal to the host system 12 indicating a departure request comprising at least the location contained in the leaving from section 602 and the departure time contained in the scheduling section 603. The book this trip selectable indicator 605 may provide the passenger 15 with a price associated with the requested rideshare.

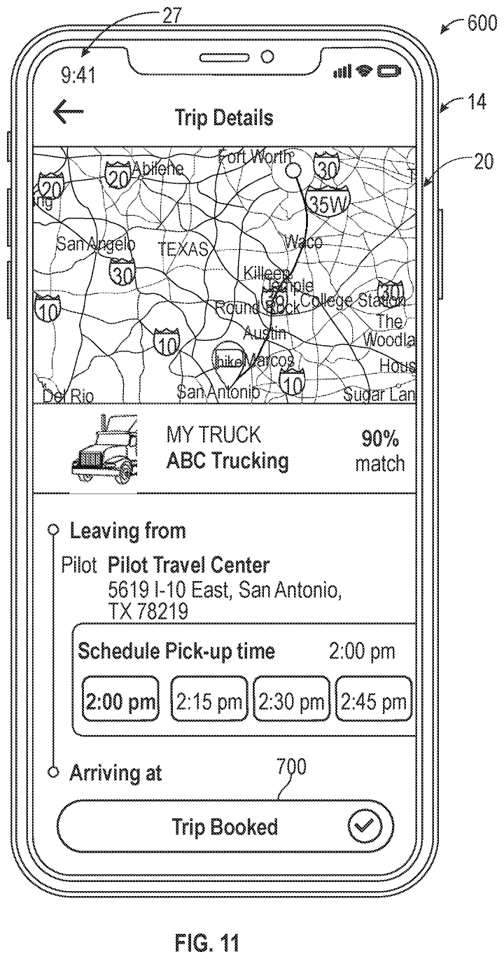

After reviewing the information on the passenger scheduling screen 600, the passenger 15 may indicate, via the input device 21, a desire to request a rideshare by clicking or otherwise selecting the book this trip selectable indicator 605 (e.g., as described above in regards to decision step 110). Selection of the book this trip selectable indicator 605 will cause the processor 24 executing the application 27 to send a signal to the host system 12 indicating a confirmation of a rideshare request (i.e., a rideshare request confirmation). Selection of the book this trip selectable indicator 605 causes the processor 24 executing the application 27 to display a trip booked confirmation icon 700 on the passenger scheduling screen 600, as shown in FIG. 11.

Referring now to FIG. 11, shown therein is an illustration of an exemplary embodiment of the passenger scheduling screen 600 of FIG. 10 further comprising a trip booked confirmation icon 700 constructed in accordance with the present disclosure. It should be noted that the trip booked confirmation icon 700 may be displayed as a pop-up screen or other passenger device notification such as a phone notification.

In one embodiment, when the host processor 35 of the host system 12 receives the confirmation of the rideshare request, the rideshare request may be considered “booked”, i.e., the rideshare request has been accepted by all parties and may be completed by the passenger 15 and the autonomous vehicle associated with the autonomous vehicle device 16. In one embodiment, the host processor 35 may store the confirmation in the host memory 30, for example, in the database 32.

Referring back to FIG. 10, selection by the passenger 15 of the book this trip selectable indicator 605 on the passenger scheduling screen 600 will cause the processor 24 executing the application 27 to send a signal to the host system 12 indicating the passenger is seeking confirmation from the driver. The host system 12 will send a signal to the autonomous vehicle device 16 seeking acceptance of the rideshare request (e.g., as described above in regards to step 112).

As described above in regards to decision step 114, the authority (e.g., the autonomous vehicle and/or motor control authority) may indicate acceptance of rideshare request by clicking or otherwise selecting an accept selectable indicator. Alternatively, the autonomous vehicle and/or motor control authority may deny the request by clicking or otherwise selecting a decline selectable indicator (not shown). When the autonomous vehicles and/or motor control authority clicks the accept selectable indicator (not shown), the processor 24a executing the application 27a is programmed to send a signal via the network 18 to the host system 12 indicating acceptance of the rideshare request by the authority, such as the accompanying driver 17.

Upon receiving the signal indicating acceptance of the rideshare request, the host processor 35 is programmed to send a signal via the network 18 to the passenger device 14 indicating that the rideshare request has been accepted. At this point, the host processor 35 may process payment from the passenger 15 for the requested rideshare. Payment processing may be accomplished by way of a credit card, or debit card payment, for example. Information regarding the passenger's credit or debit card can be stored on in the host memory 30 of the host system 12 and used to process and pay for the passenger's rideshare. In other embodiments, the host processor 35 may communication with one or more third-party payment processors via the network 18 to process the payment from the passenger 15. In this embodiment, the passenger's payment information is not stored in the host system 12, however the host processor 35 may store a confirmation of successful payment processing from the third-party payment processor in the host memory 30 such as in the database 32.

The host processor 35 may also be programmed to automatically indicate that the autonomous vehicle that accepted the rideshare request is marked as no longer available (such as in the host memory 30 or the database 32), and thus, would not show on a list of available autonomous vehicles when another passenger 15 sends a rideshare request. In such an embodiment, the host processor 35 of the host system 12 may be programmed to send a signal via the network 18 to the autonomous vehicle device 16 indicating an availability status of not available. Information with respect to availability/unavailability of an autonomous vehicle (e.g., an availability status) can be stored in the database 32.

Referring now to FIG. 12, shown therein is an illustration of an exemplary embodiment of a rideshare tracking screen 800 constructed in accordance with the present disclosure. Upon receiving the signal indicating that the rideshare request has been accepted, the processor 24 executing the application 27 on the passenger device 14 may be programmed to display the rideshare tracking screen 800 on the output device 20, as shown in FIG. 12. In one embodiment, the rideshare tracking screen 800 is provided with a map 801, a visual indicator of the pick-up point location indicated by a marker 802, a line 803 or other visual indicator showing the path the autonomous vehicle will travel to arrive at the drop-off point location, a location marker 804 or other visual indicator of a real-time location of the autonomous vehicle device 16, an ETD section 805 or other visual indication of the estimated time of departure of the autonomous vehicle, an autonomous vehicle banner 806, a call selectable indicator 807 to contact the motor control authority associated with the selected autonomous vehicle, a schedule change selectable indicator 808 to request another time of departure or pick-up point location and/or a drop-off point location, and a cancel trip selectable indicator 809.

After indicating acceptance of the rideshare request, the processor 24a executing the application 27a on the autonomous vehicle device 16 may be programmed to automatically cause the processor 24a to read the device locator 23a of the autonomous vehicle device 16 and send a signal indicating real-time updates of the location of the autonomous vehicle device 16 via the communication device 25a to the host system 12 via the network 18. Upon receipt of the signal, the host processor 35 of the host system 12 may be programmed to send a signal indicating the autonomous vehicle device 16 location to the passenger device 14 to update the passenger 15 as the autonomous vehicle travels to the pick-up point location. The processor 24 executing the application 27 on the passenger device 14 may be programmed to display the current estimated time of departure of the autonomous vehicle as an ETD section 805 on the rideshare tracking screen 800 on the output device 20.

In one embodiment, the processor 24 executing the application 27 may cause the output device 20 of the passenger device 14 to display a current rideshare screen (not shown) when the host processor 35 of the host system 12 determines that the passenger device 14 and the autonomous vehicle device 16 are within a predetermined distance of one another for a predetermined period of time, as described above in more detail. In one embodiment, the current rideshare screen is provided with a map (such as the map 127 shown in FIG. 5), a first visual marker of the pick-up point location (such as the marker 129 of FIG. 5), a line or other visual indicator showing the path the autonomous vehicle will travel to arrive at the drop-off point location (such as line 803 shown in FIG. 12), a second visual marker 607 (shown in FIG. 10) or other visual indicator of drop-off point location, a location marker (not shown) or other visual indicator of the current position of the passenger device 14, and an ETA section (not shown) or other visual indication of the estimated time of arrival of the passenger at the drop-off point location.

In one embodiment, the host processor 35 of the host system 12 may be programmed to ping or otherwise contact the passenger device 14 constantly or at predetermined intervals to update the location of the passenger device 14. Upon receipt of the current location of the passenger device 14, the host processor 35 may be programmed to update the database 32 to indicate the current location of the passenger device 14. In this way, the host processor 35 may keep track of the autonomous vehicle during the rideshare trip and update the current rideshare screen.

In one embodiment, the processor 24 provides the passenger 15 with a break request option on the output device 20. When the passenger 15 interacts with the break request option, the processor 24 may receive a break request (optionally including a break request type), and transmit the break request to the host processor 35. The host processor 35 may then determine a break location along the path of the trip itinerary. For example, if the break request has a break type of bio-break, the host processor 35 may identify one or more truck stop or refueling station along the path of the trip itinerary as the break location. The host processor 35 may the transmit a signal to the processor 24a to cause the processor 24a to send a signal, via the AV control device 22, to the autonomous vehicle thereby causing the autonomous vehicle to stop at the break location. Alternatively, if the break type is a stretch break, the host processor 35 may further consider locations along the path of the trip itinerary such as a scenic overlook or the like. In another embodiment, if the break type is an emergency break, the host processor 35 may further consider locations where it may be safe for the autonomous vehicle to stop as an emergency location, contact emergency services, and provide the emergency location to emergency services. In this embodiment, the host processor 35 may or may not consider the path of the trip itinerary in determining the emergency location.

In one embodiment, the processor 24a may communicate with the autonomous vehicle, via the AV control device 22, to cause the autonomous vehicle to wait at the break location until instructed to continue along the path of the trip itinerary. In some embodiments, the processor 24a may determine that the passenger is present in the autonomous vehicle prior to causing the AV control device 22 to send the control signal to the autonomous vehicle thereby causing the autonomous vehicle to continue along the path of the trip itinerary. In one embodiment, the processor 24a may communicate with the AV control device 22 to determine whether the passenger 15 is present in the autonomous vehicle by, for example, receiving an occupancy signal from one or more occupancy sensor present in the autonomous vehicle, such as a weight sensor, a movement sensor, a PIR sensor, a SONAR sensor, and/or the like. Additional occupancy sensors may include, for example, a switch that must be switched by the passenger 15 or an NFC/RFIC sensor that the passenger 14 must interact with, e.g., by placing the passenger device 14 on and/or off the sensor, whereby changing position of the passenger device 14 may be considered occupancy in the autonomous vehicle as opposed to incidental placement of the passenger device 14 on or near the occupancy sensor prior to exiting the autonomous vehicle. The processor 24a may use the occupancy signal to determine whether the passenger 15 is present in the autonomous vehicle prior to causing the autonomous vehicle to continue along the path of the trip itinerary.

Similarly, the processor 24a may communicate with the autonomous vehicle, via the AV control device 22, to cause the autonomous vehicle to wait at the break location until instructed to continue along the path of the trip itinerary by the host processor 35. For example, the host processor 35 may send one or more notification to the passenger device 14 requesting that the passenger 15 interact with the notification when the passenger 15 has returned to the autonomous vehicle. When the passenger 15 interacts with the notification, or otherwise indicates, that the passenger 15 is present in the autonomous vehicle, the host processor 35 may send the occupancy signal to the processor 24a.

In yet another embodiment, the passenger device 14 may provide a notification to the passenger 15 requesting that the passenger 15 indicate that the passenger 15 has returned to the autonomous vehicle. For example, the passenger 15 may interact with the input device 21a of the autonomous vehicle device 16 to indicate that the passenger 15 has returned to the autonomous vehicle. The processor 24a may then send a resume signal via the AV control device 22 thereby causing the autonomous vehicle to continue along the path of the trip itinerary. Alternatively, the passenger 15 may place the passenger device 14 in a particular location associated with the input device 21a of the autonomous vehicle device 16 to cause the processor 24a to receive the occupancy signal from the passenger device 14, such as, for example, via NFC or RFIC communication. The processor 24a, after receiving the occupancy signal, may then send a resume signal via the AV control device 22 thereby causing the autonomous vehicle to continue along the path of the trip itinerary.

In one embodiment, the host processor 35 of the host system 12 may be programmed to continually update the location of the passenger device 14 until a triggering event happens. For instance, a triggering event may include, but is not limited to, the passenger device 14 sending a signal to the host system 12 via the network 18 indicating the passenger has arrived at the drop-off point location. The processor 24 executing the application 27 will stop sending the current location of the passenger device 14 and the host processor 35 of the host system 12 may be programmed to automatically mark the availability status of the autonomous vehicle as available once the triggering event occurs. In this way, the autonomous vehicle will be available to accept future rideshare requests.

Referring now to FIG. 13, shown therein is an illustration of an exemplary embodiment of the passenger authorization manifest 900 constructed in accordance with the present disclosure. As shown, the passenger authorization manifest 900 is provided with an authority owner's name field 901, a vehicle identifier field 902, a passenger's name field 903, a motor carrier name and number field 904, a pick-up point location field 905, a drop-off point location field 906, a date field 907, and an electronic signature field 908. The host processor 35 of the host system 12 is programmed to update the authority owner's name field 901, the vehicle identifier field 902, and the motor carrier name and number field 904 using the autonomous vehicle and/or accompanying driver profile information, and the passenger's name field 903, the pick-up point location field 905, and the drop-off point location field 906 using the passenger profile information. The host processor 35 may determine an authority termination date based on a date of travel, (e.g., based on the pick-up date and/or drop-off date of the trip itinerary) the authority termination date being inserted into the date field 907. In one embodiment, the host processor 35 may populate the vehicle identifier field 902 with one or more of: the motor carrier name, the truck number, and/or the accompanying driver name.

The host processor 35 of the host system 12 is programmed to updated the electronic signature field 908 upon confirmation of the rideshare request by the authority, such as the accompanying driver 17, the autonomous vehicle device 16, and/or the motor carrier authority. In some embodiments, the host processor 35 of the host system 12 sends the passenger authorization manifest 900 to the external system 19 to receive an electronic signature for the electronic signature field 908. Upon completion of the passenger authorization manifest 900, the host processor 35 of the host system 12 is programmed to send the completed passenger authorization manifest 900 to the external system 19. In one embodiment, the host processor 35 may automatically insert the electronic signature of the authority (e.g., authority owner) without interaction by the authority owner. For example, the authority owner may pre-approve all rideshare requests having particular properties. In this case, the rideshare request may be automatically approved by the authority owner without intervention. In other words, electronically signing the passenger authorization manifest 900 may be automatically performed without interaction from the authority owner, that is, the electronic signature of the authority owner may be provided without interaction of the authority owner, to the electronic signature field 908.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A system, comprising:
one or more processors; and
one or more memories comprising a non-transitory computer readable medium storing processor-executable instructions that when executed by the one or more processors causes the one or more processors to:
receive one or more trip itineraries from a plurality of autonomous vehicle devices, each trip itinerary of the one or more trip itineraries having an autonomous vehicle identifier, at least one pick-up region along a route to a final destination, and an autonomous vehicle time associated with the at least one pick-up region, each autonomous vehicle identifier being linked with autonomous vehicle data associated with a particular autonomous vehicle, the autonomous vehicle data including an authority owner name, a motor carrier name, and a motor carrier number;
receive a rideshare request from at least one passenger device, the rideshare request identifying passenger data, and having a pick-up location, a drop-off location, and a pick-up time, the at least one passenger device being associated with the passenger data, the passenger data identifying at least a passenger name;
match the rideshare request with at least one trip itinerary of the one or more trip itinerary as a list of matched itineraries;
generate a passenger manifest including the passenger name identified by the rideshare request, the autonomous vehicle data identified by a particular trip itinerary of the list of matched itineraries, and a signature of an authority owner, the passenger manifest further including at least the pick-up location, the drop-off location, a date of travel based on the autonomous vehicle time, a motor carrier name, and a motor carrier number;
book a ridesharing trip including the passenger with the particular autonomous vehicle associated with the particular trip itinerary;
provide the autonomous vehicle device associated with the particular trip itinerary with the rideshare request;
transmit a rideshare request confirmation to the passenger device to cause the passenger device to display the rideshare request confirmation; and
store the passenger manifest in the one or more memories.

2. The system of claim 1, wherein the autonomous vehicle data further identifies an accompanying driver preference data comprising responses to a first predetermined set of questions indicative of an accompanying driver preference.

3. The system of claim 1, wherein the passenger data further identifies a passenger preference data comprising responses to a second predetermined set of questions indicative of a passenger preference.

4. The system of claim 1, wherein the at least one pick-up region is a county, city, village, township, district, or other administrative division.

5. The system of claim 1, wherein the at least one pick-up region includes a plurality of pick-up locations, and wherein the processor-executable instructions further cause the one or more processors to:
display, on the passenger device, one or more selectable indicators, each selectable indicator of the one or more selectable indicators being associated with a particular pick-up location of the plurality of pick-up locations; and
receive, from the passenger device, a selected selectable indicator indicative of a selection of the particular pick-up location associated with the selected selectable indicator.

6. The system of claim 5, wherein the at least one pick-up region further includes a plurality of drop-off locations.

7. The system of claim 1, wherein the pick-up time is within the autonomous vehicle time associated with each of the at least one pick-up region.

8. The system of claim 1, wherein the signature of the authority owner is an electronic signature.

9. The system of claim 8, wherein the signature of the authority owner is provided without interaction by the authority owner.

10. The system of claim 1, wherein the one or more memories further stores instructions that cause the one or more processors to:
transmit the passenger manifest to an external system associated with the authority owner.

11. A method, comprising:
receiving, by a host system having a host processor and a host memory, one or more trip itineraries from a plurality of autonomous vehicle devices, each trip itinerary of the one or more trip itineraries having an autonomous vehicle identifier, at least one pick-up region along a route to a final destination, and an autonomous vehicle time associated with each pick-up region, each autonomous vehicle identifier being associated with autonomous vehicle data associated with a particular autonomous vehicle, the autonomous vehicle data including an authority owner name, a motor carrier name, and a motor carrier number;
receiving a rideshare request from at least one passenger device, the rideshare request identifying passenger data, and having a pick-up location, a drop-off location, and a pick-up time, the at least one passenger device being associated with the passenger data, the passenger data identifying at least a passenger name;
matching the rideshare request with at least one trip itinerary of the one or more trip itinerary as a list of matched itineraries;
generating a passenger manifest identifying the passenger name identified by the rideshare request, the autonomous vehicle data identified by a particular trip itinerary of the list of matched itineraries, and a signature of an authority owner, the passenger manifest further including at least the pick-up location, the drop-off location, a date of travel based on the autonomous vehicle time, a motor carrier name, and motor carrier number;
booking a ridesharing trip including the passenger with the particular autonomous vehicle associated with the particular trip itinerary;
providing the autonomous vehicle device associated with the particular trip itinerary with the rideshare request;
transmitting a rideshare request confirmation to the passenger device associated with the rideshare request to cause the passenger device to display the rideshare request confirmation; and
storing the passenger manifest in the host memory.

12. The method of claim 11, wherein the autonomous vehicle data further identifies accompanying driver preference data comprising responses to a first predetermined set of questions indicative of accompanying driver preference, and wherein matching the rideshare request with the at least one trip itinerary further comprises matching the rideshare request with at least one trip itinerary based at least in part on the accompanying driver preference data.

13. The method of claim 11, wherein the passenger data further identifies passenger preference data comprising responses to a second predetermined set of questions indicative of a passenger preference, and wherein matching the rideshare request with the at least one trip itinerary further comprises matching the rideshare request with at least one trip itinerary based at least in part on the passenger preference data.

14. The method of claim 11, wherein the at least one pick-up region is a county, city, village, township, district, or other administrative division.

15. The method of claim 11, wherein the at least one pick-up region contains a plurality of pick-up locations, and wherein matching the rideshare request with the at least one trip itinerary further comprises matching the pick-up location of the rideshare request with at least one pick-up location of the plurality of pick-up locations of the at least one pick-up region of the at least one trip itinerary.

16. The method of claim 15, wherein the at least one pick-up region further contains a plurality of drop-off locations, and wherein matching the rideshare request with the at least one trip itinerary further comprises matching the pick-up location of the rideshare request with the at least one pick-up location of the plurality of pick-up locations of the at least one pick-up region of the at least one trip itinerary and the drop-off location of the rideshare request with at least one drop-off location of the plurality of drop-off locations of the at least one pick-up region of the at least one trip itinerary.

17. The method of claim 11, wherein the pick-up time is within the autonomous vehicle time associated with each pick-up region, and wherein matching the rideshare request with the at least one trip itinerary further comprises selecting one or more of the trip itineraries having the autonomous vehicle time at least partially overlapping with the pick-up time as the list of matched itineraries.

18. The method of claim 11, wherein the signature of an authority owner is an electronic signature, and wherein generating the passenger manifest further includes including the electronic signature.

19. The method of claim 18, wherein including the electronic signature is performed without interaction by the authority owner.

20. The method of claim 11, wherein storing the passenger manifest in the host memory further includes providing the passenger manifest to the authority owner.
